(19) United States
(12) Patent Application Publication
(10) Pub. No.: US 2013/0241933 A1
(43) Pub. Date: Sep. 19, 2013

(54) METHODS AND SYSTEMS FOR PROVIDING INTEREST RATE SIMULATION DISPLAYS

(71) Applicant: BARCLAYS CAPITAL INC., New York, NY (US)

(72) Inventors: Husnu Kipcak, New York, NY (US); Michael Lawley, New York, NY (US); Kevin Thatcher, New York, NY (US)

(73) Assignee: BARCLAYS CAPITAL INC., New York, NY (US)

(21) Appl. No.: 13/750,478

(22) Filed: Jan. 25, 2013

Related U.S. Application Data
(63) Continuation of application No. 11/438,118, filed on May 18, 2006, now abandoned.
(60) Provisional application No. 60/682,605, filed on May 18, 2005.

(51) Int. Cl. G06Q 40/06; G06T 11/20

(52) U.S. Cl. CPC G06Q 40/06; G06T 11/206
USPC 345/440.2; 705/36 R

(57) ABSTRACT

In one aspect, the invention comprises a computer system comprising means for displaying on a computer screen a chart illustrating level and volatility of a projected accounting performance based on a plurality of possible future interest rates, wherein the chart comprises a 50th percentile line, a 95th percentile line, and a 5th percentile line, and wherein the 50th percentile line, 95th percentile line, and 5th percentile line represent probability distribution over time of the projected accounting performance. In various embodiments: (1) for each of the one or more vertical bars, the uppermost dot represents a 95% best case for projected accounting performance and the lowermost dot represents a 95% worst case for projected accounting performance; and (2) the projected accounting performance comprises one or more of: net interest margin, interest expense, interest income, and present value.

### CROSS-REFERENCE TO RELATED APPLICATIONS

This application claims the benefit of U.S. Provisional Application No. 60/682,605, filed May 18, 2005. The entire contents of that provisional application are incorporated herein by reference.

### SUMMARY

In one embodiment, the present invention comprises simulation analyses and displays that enable visualization of potential future yield curve (“YC”) paths. After generating yield curve data, relevant interest rates are applied to assets or liabilities in an issuer's portfolio. This enables generation of a probabilistic map of future interest income and future interest expense based on simulated interest rates and particular characteristics of the issuer's asset and liability portfolios. In another embodiment, present value is used instead of interest expense.

In one embodiment, after a probabilistic map is developed, potential strategies are layered in using derivative securities or changes to the level of assets or liabilities in order to estimate the impact that the strategies will have on the various probabilities of future interest expense and interest income possibilities.

This data preferably is presented in a graphical form that distills the main components of risk and return of various strategies, which in turn allows clients to make more informed decisions on the merits and risks of various strategies. These presentations provide clients with better understanding and insight, and have been used to help corporate boards build actionable plans to augment their risk management strategies.

A preferred embodiment uses two or more different assumptions for future interest rates and applies historical volatilities and correlations to address the stochastic elements.

For a particular company, an estimate of assets and liabilities that earn or pay interest may be used. At least one embodiment can work with summary data, such as maturity buckets, average coupon, duration, and floating rate sensitivity, or an extensive analysis using every asset or liability in the client's portfolio may be run. The manner in which data is presented to clients helps those clients make better decisions.

In one aspect, the invention comprises a computer system comprising means for displaying on a computer screen a chart illustrating level and volatility of a projected accounting performance based on a plurality of possible future interest rates, wherein the chart comprises a 50th percentile line, a 95th percentile line, and a 5th percentile line, and wherein the 50th percentile line, 95th percentile line, and 5th percentile line represent probability distribution over time of the projected accounting performance.

In various embodiments: (1) wherein the 95th percentile line and the 5th percentile line form a cone that models potential volatility of the projected accounting performance; (2) the projected accounting performance is projected accounting performance per quarter; (3) the projected accounting performance is based on at least one interest rate scenario; (4) the at least one interest rate scenario comprises one or more of: a forwards scenario; an X/Y mean reversion scenario; a Z year pattern assumption scenario; and an inverted yield curve scenario; (5) the accounting performance comprises at least one of: net interest margin, interest expense, interest income, and present value; and (6) the accounting performance comprises a combination of two or more of: net interest margin, interest expense, interest income, and present value.

In another aspect, the invention comprises a computer system comprising: means for calculating output of an interest rate simulation model; and means for receiving the output and based thereon displaying on a computer screen a median high-low chart comprising one or more vertical bars, wherein each of the one or more vertical bars represents a probability distribution, wherein each of the one or more vertical bars comprises a center dot, an uppermost dot, and a lowermost dot, and wherein the center dot represents an expected level of interest cost.

In various embodiments: (1) for each of the one or more vertical bars, the uppermost dot represents a 95% best case for projected accounting performance and the lowermost dot represents a 95% worst case for projected accounting performance; (2) the projected accounting performance comprises one or more of: net interest margin, interest expense, interest income, and present value; (3) at least one of the one or more vertical bars corresponds to an interest rate scenario; (4) the interest rate scenario comprises at least one of: a forwards scenario; an X/Y mean reversion scenario; a Z year pattern assumption scenario; and an inverted yield curve scenario; (5) the chart comprises, for at least one of the one or more vertical bars that corresponds to an interest rate scenario, one or more vertical bars corresponding to a risk management product scenario; and (6) the risk management product scenario comprises a scenario for one or more of: swaps, collars, caps, floors, swaptions, and forward starting swaps.

In another aspect, the invention comprises a method comprising: displaying on a computer screen a chart illustrating level and volatility of a projected accounting performance based on a plurality of possible future interest rates, wherein the chart comprises a 50th percentile line, a 95th percentile line, and a 5th percentile line, and wherein the 50th percentile line, 95th percentile line, and 5th percentile line represent probability distribution over time of the projected accounting performance.

In various embodiments: (1) the 95th percentile line and the 5th percentile line form a cone that models potential volatility of the projected accounting performance; (2) the projected accounting performance is projected accounting performance per quarter; (3) the projected accounting performance is based on at least one interest rate scenario; (4) the at least one interest rate scenario comprises one or more of: a forwards scenario; an X/Y mean reversion scenario; a Z year pattern assumption scenario; and an inverted yield curve scenario; (5) the accounting performance comprises at least one of: net interest margin, interest expense, interest income, and present value; and (6) the accounting performance comprises a combination of two or more of: net interest margin, interest expense, interest income, and present value.

In another aspect, the invention comprises a method comprising: calculating output of an interest rate simulation model; receiving the output; and based on the output, displaying on a computer screen a median high-low chart comprising one or more vertical bars, wherein each of the one or more vertical bars represents a probability distribution, wherein each of the one or more vertical bars comprises a center dot, an uppermost dot, and a lowermost dot, and wherein the center dot represents an expected level of interest cost.

In various embodiments: (1) for each of the one or more vertical bars, the uppermost dot represents a 95% best case for projected accounting performance and the lowermost dot represents a 95% worst case for projected accounting performance; (2) the projected accounting performance comprises one or more of: net interest margin, interest expense, interest income, and present value; (3) at least one of the one or more vertical bars corresponds to an interest rate scenario; (4) the interest rate scenario comprises at least one of: a forwards scenario; an X/Y mean reversion scenario; a Z year pattern assumption scenario; and an inverted yield curve scenario; (5) the chart comprises, for at least one of the one or more vertical bars that corresponds to an interest rate scenario, one or more vertical bars corresponding to a risk management product scenario; and (6) the risk management product scenario comprises a scenario for one or more of: swaps, collars, caps, floors, swaptions, and forward starting swaps.

In another aspect, the invention comprises a computer system comprising: a computer operable to display on a computer screen a chart illustrating level and volatility of a projected accounting performance based on a plurality of possible future interest rates, wherein the chart comprises a 50th percentile line, a 95th percentile line, and a 5th percentile line, and wherein the 50th percentile line, 95th percentile line, and 5th percentile line represent probability distribution over time of the projected accounting performance.

In various embodiments: (1) the 95th percentile line and the 5th percentile line form a cone that models potential volatility of the projected accounting performance; (2) the projected accounting performance is projected accounting performance per quarter; (3) the projected accounting performance is based on at least one interest rate scenario; (4) the at least one interest rate scenario comprises one or more of: a forwards scenario; an X/Y mean reversion scenario; a Z year pattern assumption scenario; and an inverted yield curve scenario; (5) the accounting performance comprises at least one of: net interest margin, interest expense, interest income, and present value; and (6) the accounting performance comprises a combination of two or more of: net interest margin, interest expense, interest income, and present value.

In another aspect, the invention comprises a computer system comprising a processor operable to software operable to: calculate output of an interest rate simulation model; receive the output; and based on the output, display on a computer screen a median high-low chart comprising one or more vertical bars, wherein each of the one or more vertical bars represents a probability distribution, wherein each of the one or more vertical bars comprises a center dot, an uppermost dot, and a lowermost dot, and wherein the center dot represents an expected level of interest cost.

In various embodiments: (1) for each of the one or more vertical bars, the uppermost dot represents a 95% best case for projected accounting performance and the lowermost dot represents a 95% worst case for projected accounting performance; (2) the projected accounting performance comprises one or more of: net interest margin, interest expense, interest income, and present value; (3) at least one of the one or more vertical bars corresponds to an interest rate scenario; (4) the interest rate scenario comprises at least one of: a forwards scenario; an X/Y mean reversion scenario; a Z year pattern assumption scenario; and an inverted yield curve scenario; (5) the chart comprises, for at least one of the one or more vertical bars that corresponds to an interest rate scenario, one or more vertical bars corresponding to a risk management product scenario; and (6) the risk management product scenario comprises a scenario for one or more of: swaps, collars, caps, floors, swaptions, and forward starting swaps.

### BRIEF DESCRIPTION OF THE DRAWINGS

FIG. 1 illustrates assumptions used in a preferred embodiment.

FIGS. 2-5 depict swap rates over time for various interest rate scenarios.

FIG. 6 depicts annualized interest rate volatility.

FIGS. 7-10 depict preferred displays of results of interest rate simulations performed on a portfolio of assets and liabilities at different probability levels.

FIG. 11 illustrates distribution of Net Interest Margin (NIM) over time for various scenarios.

FIG. 12 depicts a median high-low chart for different interest rate environments at 95% confidence levels.

FIGS. 13-14 illustrate distribution of 2006 NIM over time for various scenarios.

FIGS. 15-16 illustrate distribution of 2007 NIM over time for various scenarios.

FIGS. 17-18 illustrate distribution of 2008 NIM over time for various scenarios.

FIGS. 19-20 illustrate distribution of 2009 NIM over time for various scenarios.

FIGS. 21-26 illustrate results of a blended scenario.

FIGS. 27-30 illustrate NIM impact per quarter for various scenarios.

FIGS. 31-34 provide a comparison of results for doing nothing (“current”) versus “swapped” for 2005.

FIGS. 35-38 provide a comparison of results for doing nothing (“current”) versus “swapped” for 2006.

FIGS. 39-42 provide a comparison of results for doing nothing (“current”) versus “swapped” for 2007.

FIGS. 43-46 provide a comparison of results for doing nothing (“current”) versus “swapped” for 2008.

FIGS. 47-50 provide a comparison of results for doing nothing (“current”) versus “swapped” for 2009.

FIG. 51 illustrates assumptions used in a preferred embodiment.

FIGS. 52-55 depict swap rates over time for various interest rate scenarios.

FIG. 56 depicts annualized interest rate volatility.

FIG. 57 depicts results of a Monte Carlo simulation of 1000 potential paths for 3-month LIBOR for the next five years based on the forward curve and historical volatility.

FIGS. 58-61 depict displays of interest expense per quarter for various scenarios.

FIG. 62 depicts a display of various probability distributions for various swap scenarios.

FIGS. 63-66 depict IE based on 43% floating interest rate projections.

FIGS. 67-70 depict 43% relative to current.

FIGS. 71-74 depict IE based on 60% floating interest projections.

FIGS. 75-78 depict 60% relative to current.

FIG. 79 depicts historical implied LIBOR Forward Curves at various points dating back to 1990.

FIGS. 80-81 depict annual NPV savings from a 5- and 7-year swap to floating.

FIGS. 82-83 depict ABC's “efficient frontier.”

FIGS. 84A-84B, 85A-85B and 86A-86B depict examples of risk management strategies.

### DETAILED DESCRIPTION

In one embodiment, the present invention generates a plurality of future interest rate paths to calculate a range of interest revenue and interest expense levels produced by a company's current interest rate sensitive asset and liability portfolios, respectively.

A first example herein describes preferred treatment of company “XYZ,” and illustrates exemplary data displays of preferred embodiments.

By analyzing a combined interest revenue/expense projection and evaluating impact on XYZ's future earnings, the frequency of achieving undesirable future earnings levels can be calculated.

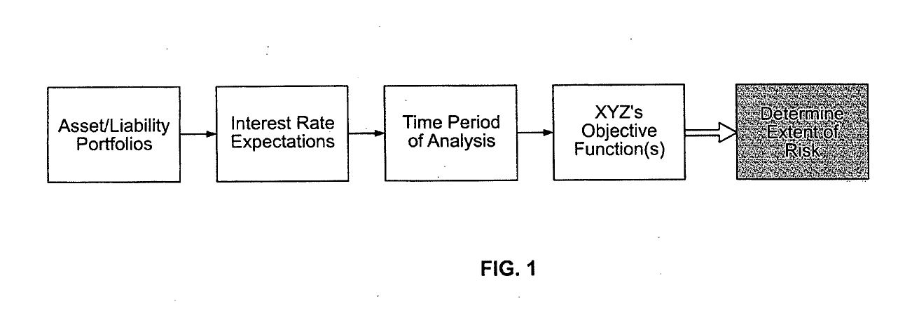

A preferred analysis is driven by the following assumptions (see FIG. 1):

Assumptions regarding asset/liability portfolios: duration; coupons; maturities; for liabilities, payment schedule and refinancing assumptions; and for assets, reinvestment assumptions.

Assumptions regarding interest rate expectations: expected future levels; speed of adjustment to future levels; and interest rate volatility and correlations.

Assumptions regarding time period of analysis: 10 years.

Assumptions regarding XYZ's objective functions: maximize expected Net Interest Margin (“NIM”); minimize volatility of expected NIM; and minimize volatility of NIM without compromising NIM. NIM is the dollar difference between interest income and interest expenses, expressed as a percentage of average earning assets.

Assumptions regarding determination of extent of risk: how much floating-rate exposure XYZ can take before compromising its objective functions; and how much risk XYZ is willing to take.

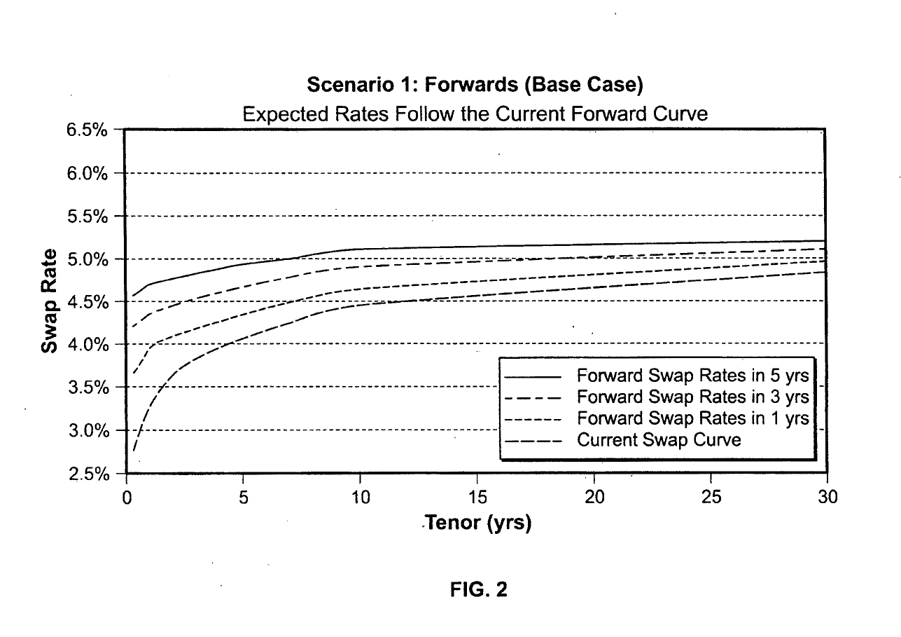

FIGS. 2-5 depict swap rates over time for various interest rate scenario assumptions. XYZ's NIM is analyzed assuming a broad range of interest rate scenarios.

FIG. 2 depicts a base case (“forwards”), which assumes that forward rates follow the current forward curve.

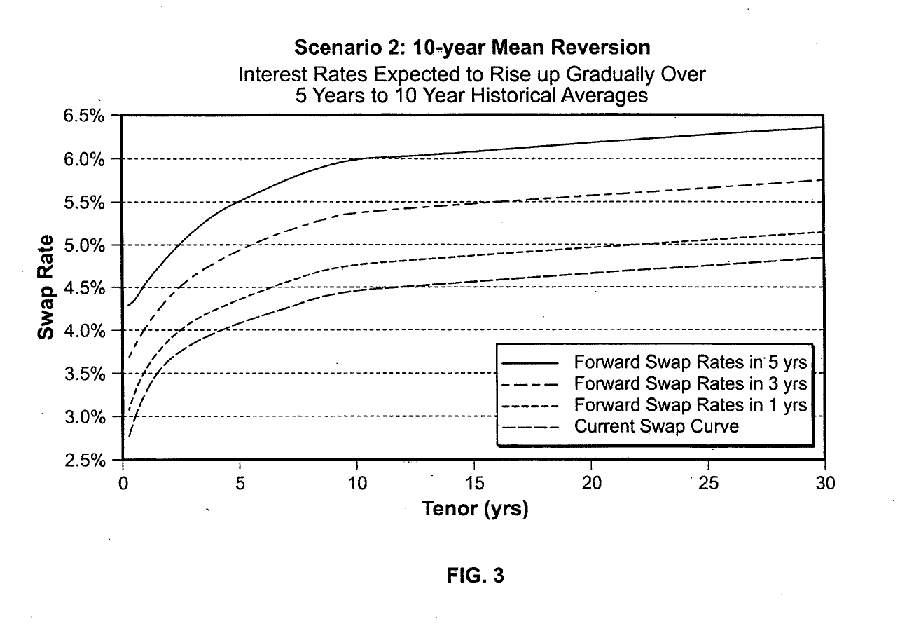

FIG. 3 illustrates a 10-year mean reversion case, in which interest rates are expected to rise gradually over 5 years, to 10 year historical averages. More generally, this scenario can be characterized as an X/Y mean reversion, where X is the number of years over which interest rates are assumed to rise (or fall), and Y is the number of years over which historical averages are taken.

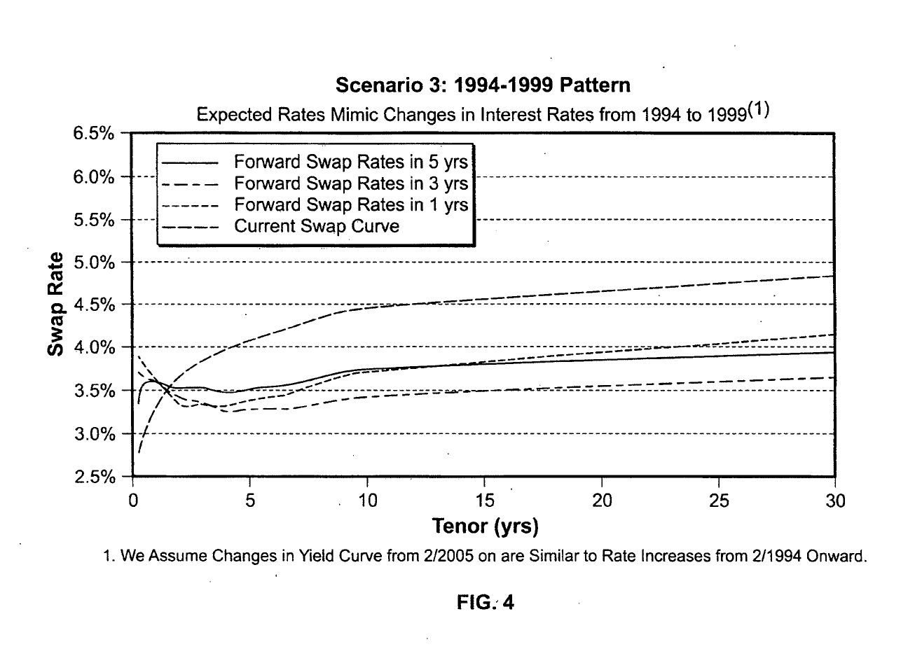

FIG. 4 illustrates a 1994-1999 pattern case, in which expected rates mimic changes in interest rates from 1994 to 1999. Generally, this is a “5 year pattern” assumption, and even more generally is a Z year pattern assumption, where Z is a specified number of years.

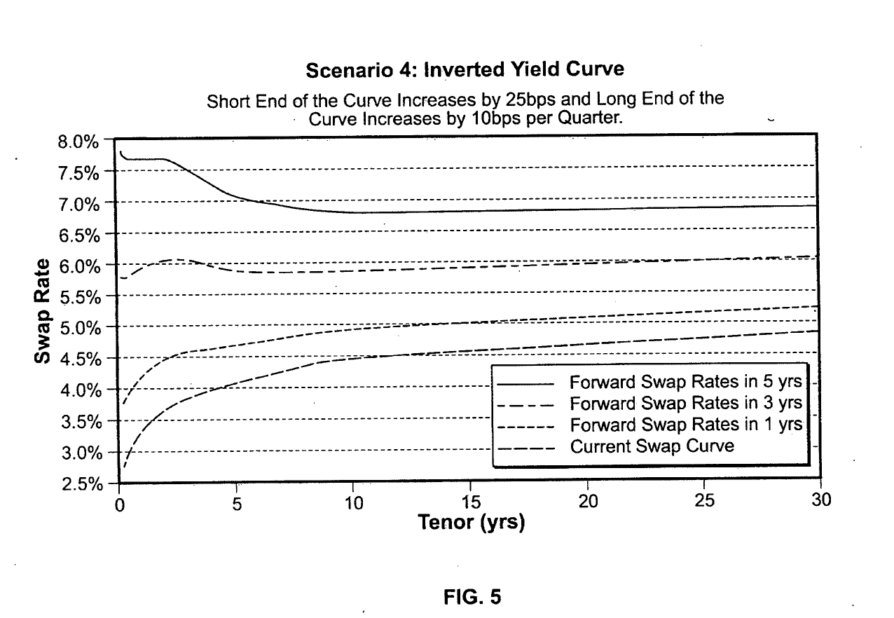

FIG. 5 illustrates an inverted yield curve case, in which the “short end” of the curve increases by 25 bps and the “long end” of the curve increases by 10 bps per quarter.

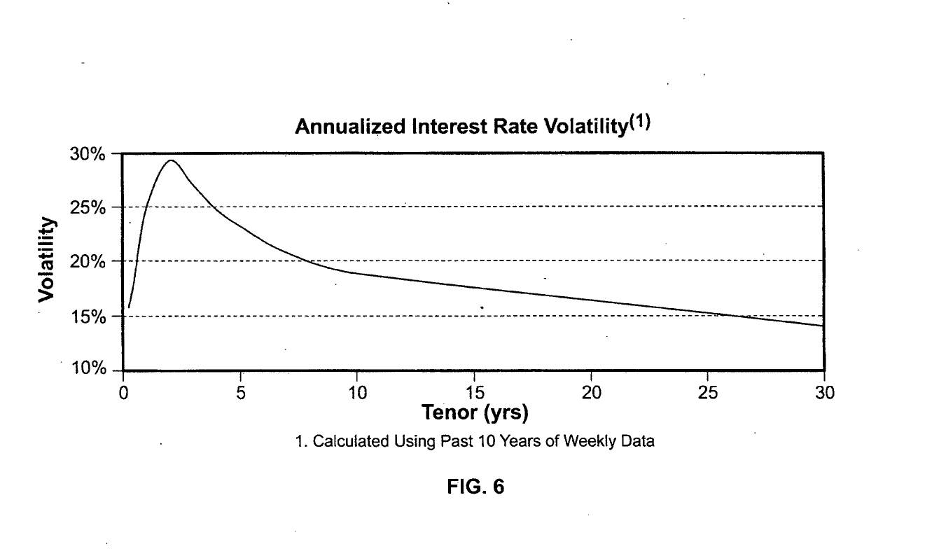

Based on interest rate movements over the past 10 years, future interest rates are estimated to move to their expected values using the interest rate volatilities and correlations shown in FIG. 6 and TABLE 1.

TABLE 1
Correlations (1995-2005)

| | 3 m | 6 m | 1 yr | 2 yr | 3 yr | 4 yr | 5 yr | 7 yr | 10 yr | 30 yr |
|---|---|---|---|---|---|---|---|---|---|---|
| 3 m | 100% | 89% | 69% | 39% | 35% | 33% | 32% | 31% | 29% | 23% |
| 6 m | 89% | 100% | 90% | 56% | 52% | 49% | 48% | 46% | 43% | 35% |
| 1 yr | 69% | 90% | 100% | 69% | 67% | 63% | 61% | 59% | 55% | 46% |
| 2 yr | 39% | 56% | 69% | 100% | 98% | 95% | 93% | 90% | 84% | 72% |
| 3 yr | 35% | 52% | 67% | 98% | 100% | 99% | 97% | 95% | 90% | 79% |
| 4 yr | 33% | 49% | 63% | 95% | 99% | 100% | 99% | 97% | 93% | 83% |
| 5 yr | 32% | 48% | 61% | 93% | 97% | 99% | 100% | 99% | 95% | 86% |
| 7 yr | 31% | 46% | 59% | 90% | 95% | 97% | 99% | 100% | 98% | 90% |
| 10 yr | 29% | 43% | 55% | 84% | 90% | 93% | 95% | 98% | 100% | 93% |
| 30 yr | 23% | 35% | 46% | 72% | 79% | 83% | 86% | 90% | 93% | 100% |

NIM Projections

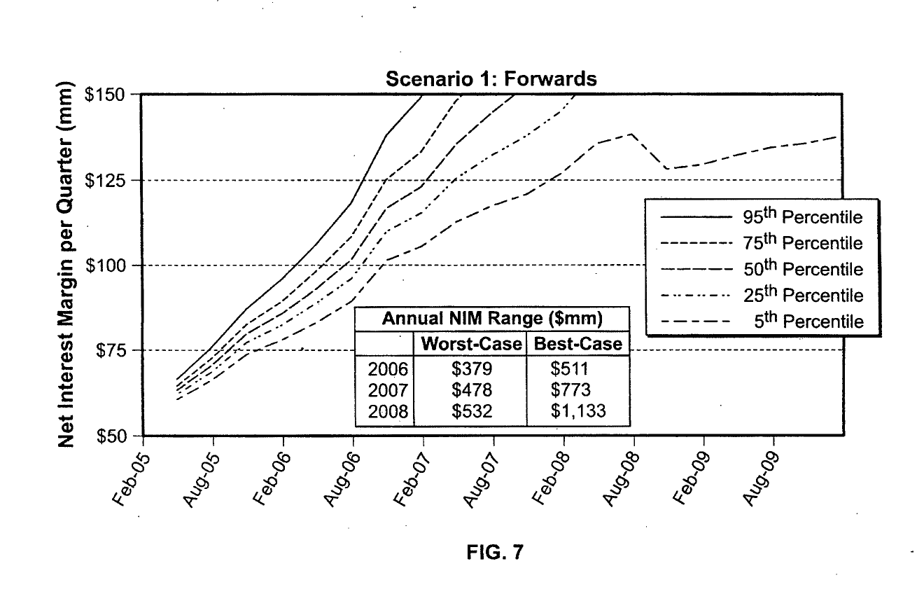

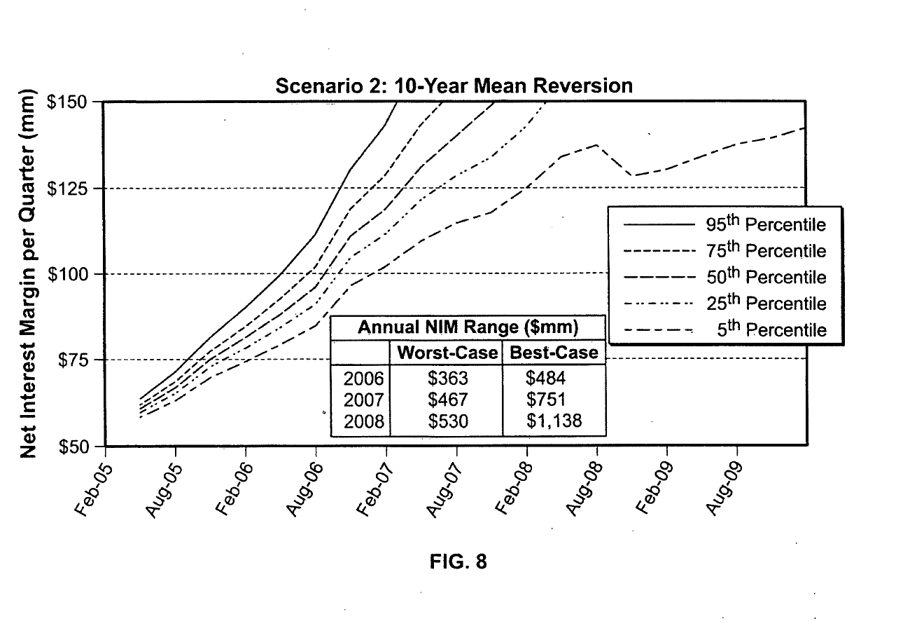

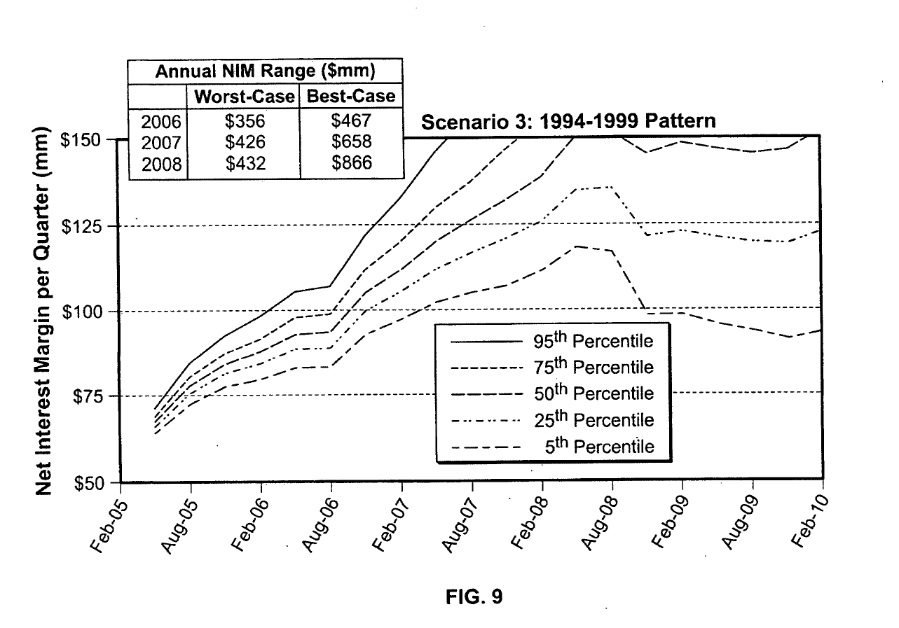

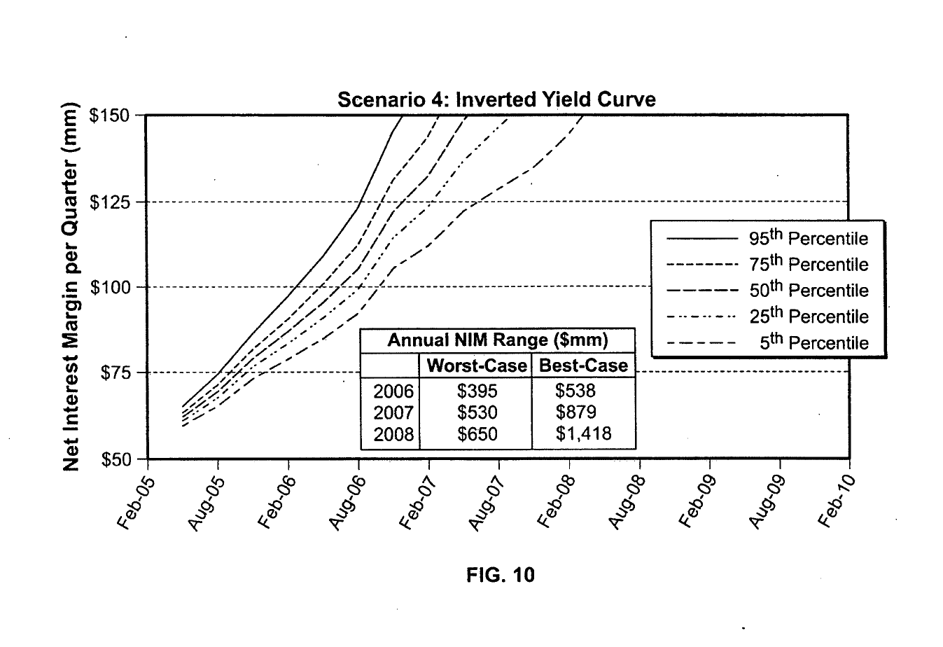

FIGS. 7-10 display outputs of interest rate simulations performed on a portfolio of assets and liabilities. FIG. 7 depicts level and “volatility” of projected NIM, under various scenarios.

The “expected” line is the 50th percentile line (the line in the middle of the five lines). The other lines further illustrate the probability distribution over time. For example, the top line is the 95th percentile line, and the bottom line is the 5th percentile line—indicating a 90% chance that the NIM will fall between those two lines. The “cone” formed by these lines models the “potential volatility” of the projected NIM.

In this example, the displays show that, while NIM is likely to increase in most scenarios, a repeat of the 1994-1999 scenario (falling rates) over the next five years would cause a deterioration in margins over time.

NIM—2005 YE Statistics

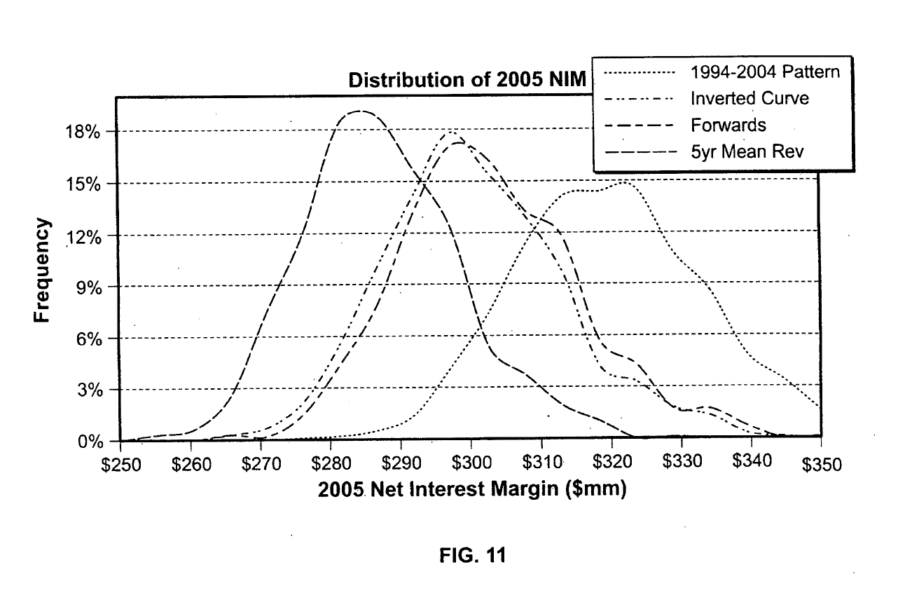

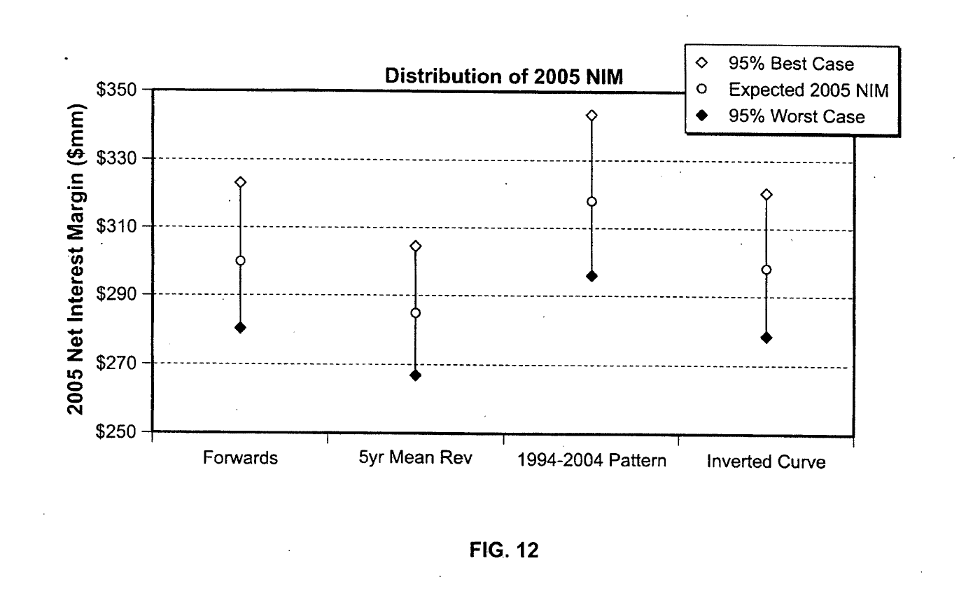

FIGS. 11-12 illustrate distribution of 2005 NIM over time for various scenarios. TABLE 2 lists summary 2005 statistics.

TABLE 2
Summary Statistics

| | Scenario | | | | |
|---|---|---|---|---|---|
| | | | 5 yr Mean | 1994-2004 | Inverted |
| | ($ mm) | Forwards | Rev | Pattern | Curve |
| Expected 2005 | | $300 | $285 | $318 | $298 |
| NIM | | | | | |
| 95% Best Case | | $323 | $304 | $343 | $320 |
| 95% Worst Case | | $280 | $267 | $296 | $278 |
| Std. Dev. | | $13 | $11 | $14 | $13 |
| 95% Value-at-Risk | | $20 | $18 | $22 | $20 |
| (VaR) | | | | | |

FIG. 12 depicts a median high-low chart. Prior use of such a chart to illustrate a risk management concept is not known. An expected level of interest cost is the center dot in each vertical bar, each of which represents a probability distribution. The uppermost and lowermost dots in each bar represent the 95% best and 95% worst cases, respectively. This clearly illustrates the corresponding risk exposures and associated expected costs for the various interest rate scenarios. This quantifies, in a manner easily perceived by even a casual viewer, the expected benefits, costs, and risks of each scenario.

Thus, FIG. 12 depicts a median high-low chart for different interest rate environments, preferably used in conjunction with one or more interest rate simulation models.

NIM—2006 YE Statistics

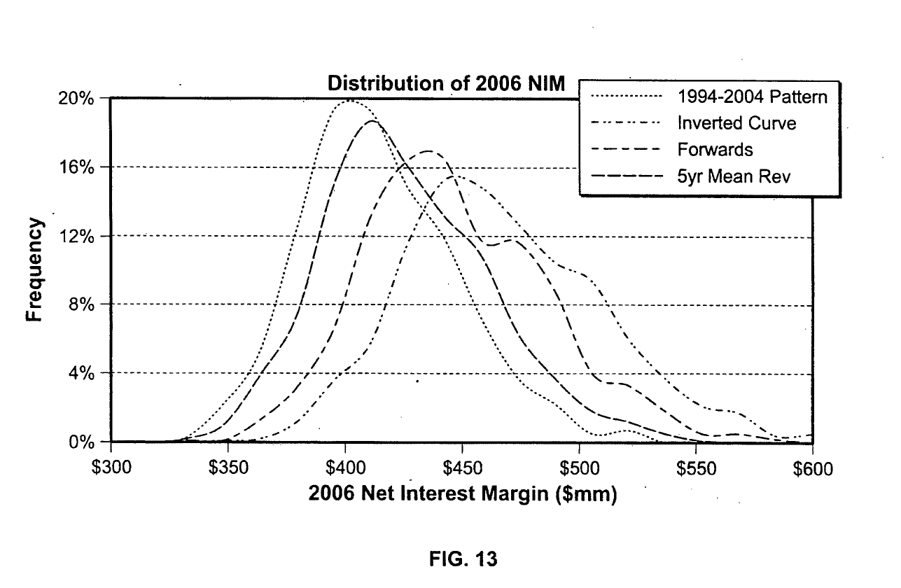

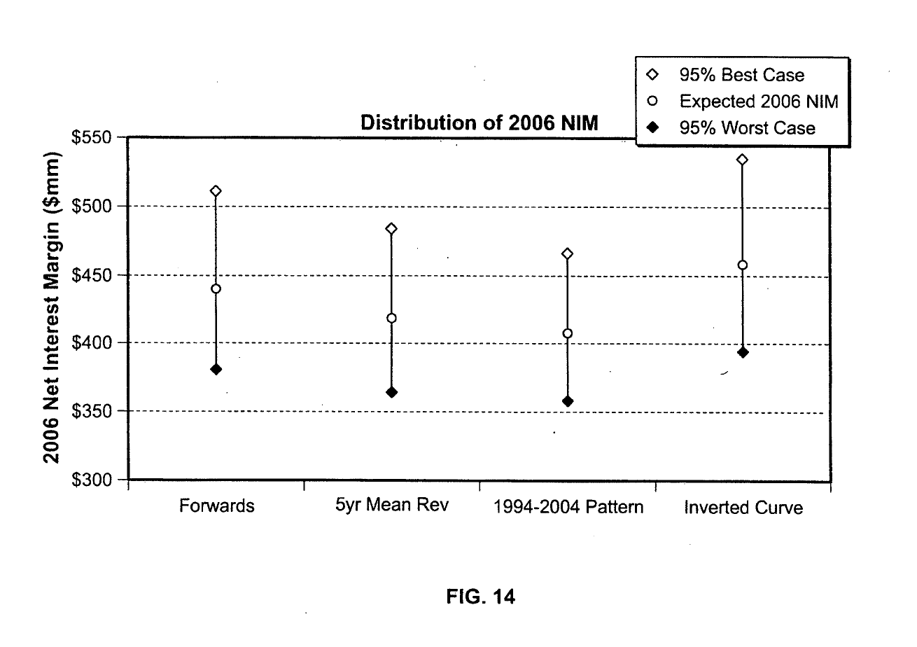

FIGS. 13-14 illustrate distribution of 2006 NIM over time for various scenarios. TABLE 3 lists summary 2006 statistics.

TABLE 3
Summary Statistics - 2006

| | Scenario | | | | |
|---|---|---|---|---|---|
| | | | 5yr Mean | 1994-2004 | Inverted |
| | ($ mm) | Forwards | Rev | Pattern | Curve |
| Expected 2006 | | $439 | $418 | $407 | $460 |
| NIM | | | | | |
| 95% Best Case | | $510 | $483 | $465 | $536 |
| 95% Worst Case | | $379 | $363 | $357 | $395 |
| Std. Dev. | | $39 | $36 | $33 | $43 |
| 95% Value-at- | | $60 | $55 | $50 | $65 |
| Risk (VaR) | | | | | |

NIM—2007 YE Statistics

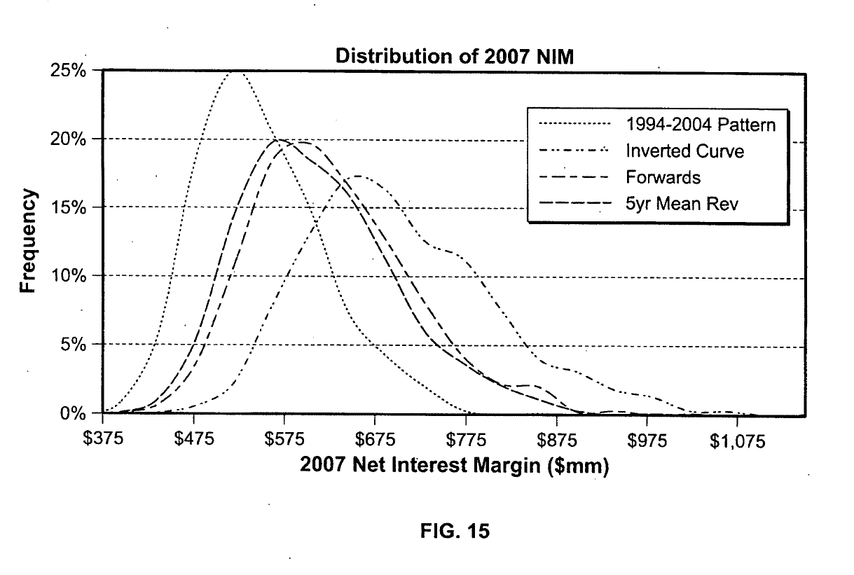

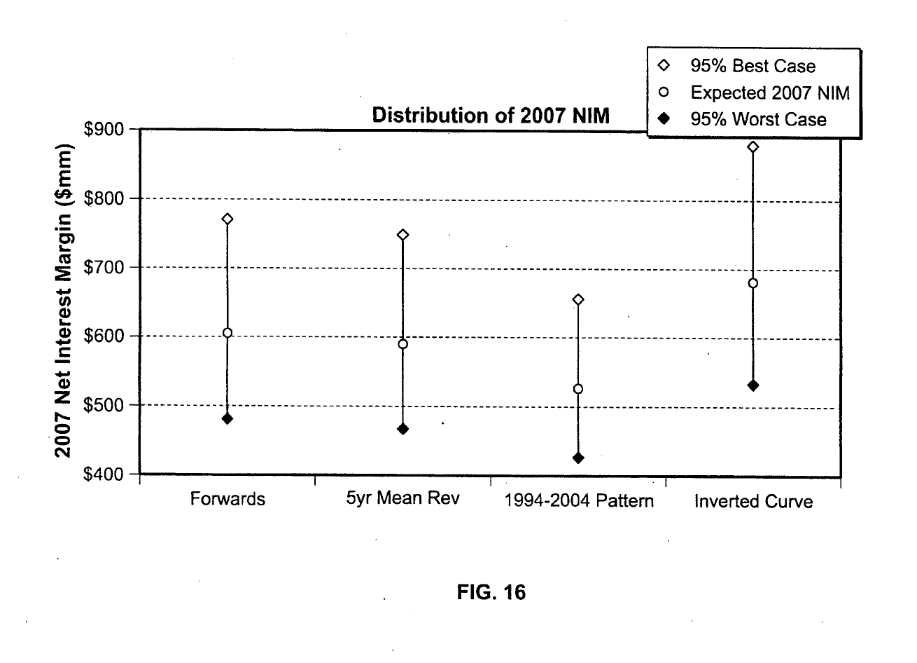

FIGS. 15-16 illustrate distribution of 2007 NIM over time for various scenarios. TABLE 4 lists summary 2007 statistics.

TABLE 4
Summary Statistics

| | Scenario | | | | |
|---|---|---|---|---|---|
| | | | 5 yr Mean | 1994-2004 | Inverted |
| | ($ mm) | Forwards | Rev | Pattern | Curve |
| Expected 2007 | | $605 | $590 | $526 | $681 |
| NIM | | | | | |
| 95% Best Case | | $770 | $749 | $656 | $880 |
| 95% Worst Case | | $480 | $468 | $427 | $532 |
| Std. Dev. | | $89 | $86 | $70 | $105 |
| 95% Value-at- | | $125 | $122 | $99 | $149 |
| Risk (VaR) | | | | | |

NIM—2008 YE Statistics

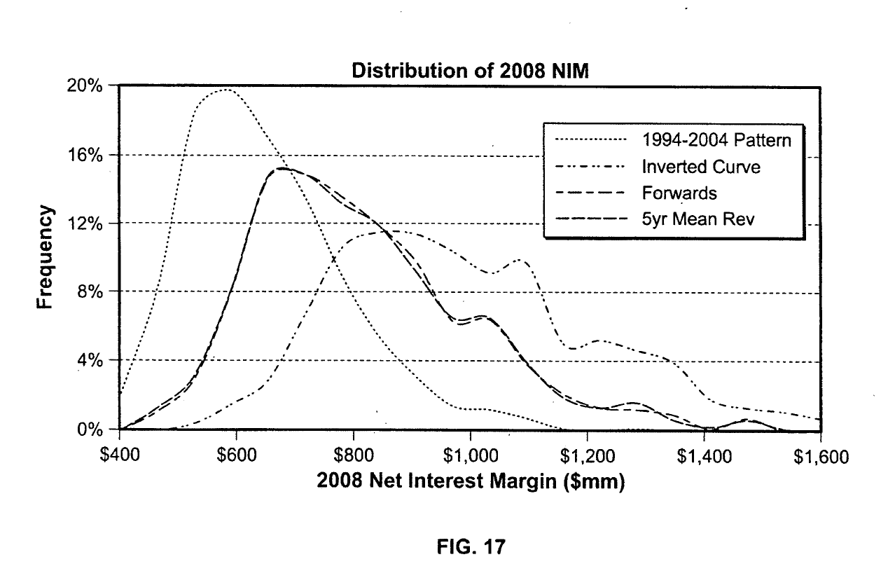

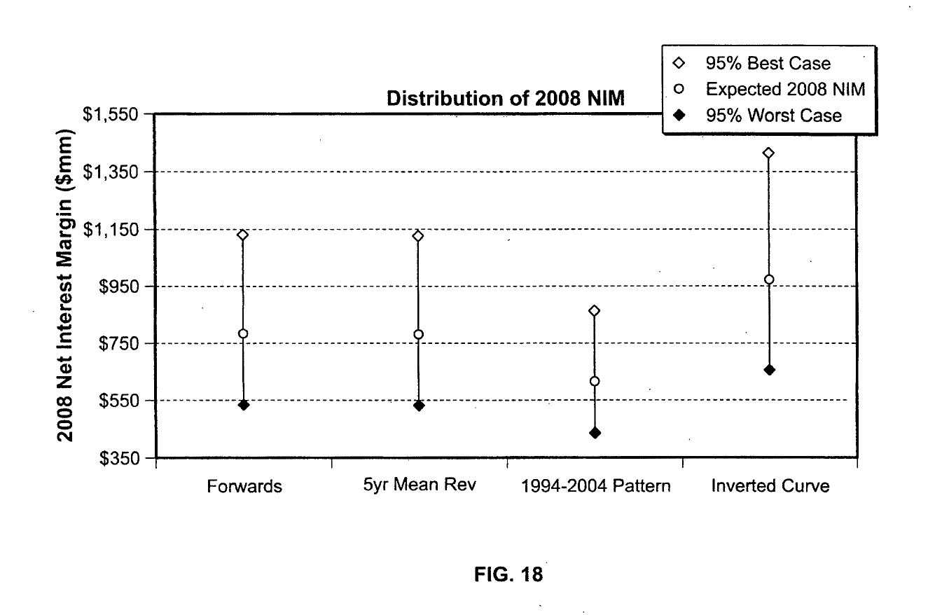

FIGS. 17-18 illustrate distribution of 2008 NIM over time for various scenarios. TABLE 5 lists summary 2008 statistics.

TABLE 5
Summary Statistics

| | Scenario | | | | |
|---|---|---|---|---|---|
| | | | 5 yr Mean | 1994-2004 | Inverted |
| | ($ mm) | Forwards | Rev | Pattern | Curve |
| Expected 2008 | | $785 | $784 | $616 | $974 |
| NIM | | | | | |
| 95% Best Case | | $1,134 | $1,132 | $864 | $1,419 |
| 95% Worst Case | | $534 | $531 | $434 | $657 |
| Std. Dev. | | $189 | $191 | $137 | $242 |
| 95% Value-at- | | $251 | $253 | $182 | $318 |
| Risk (VaR) | | | | | |

NIM—2009 YE Statistics

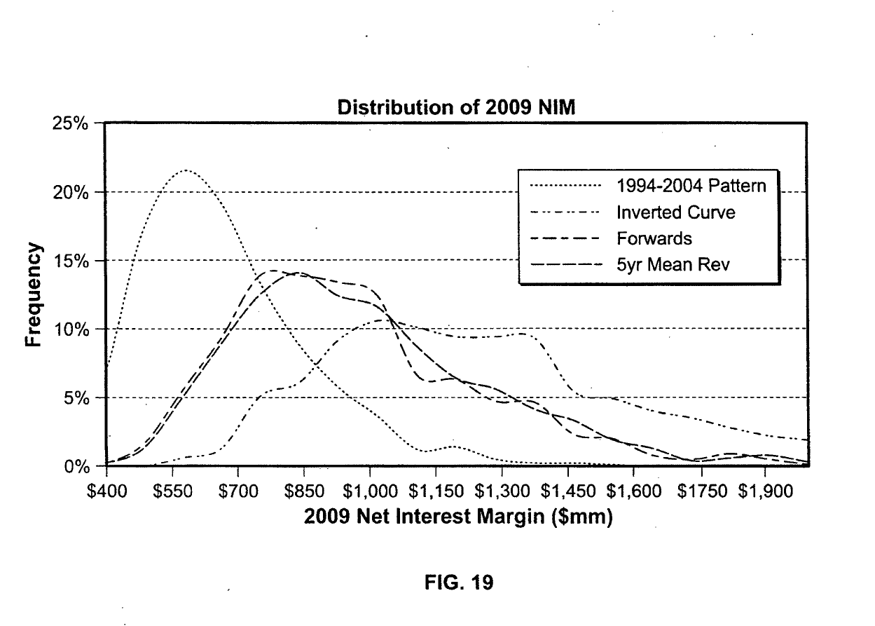

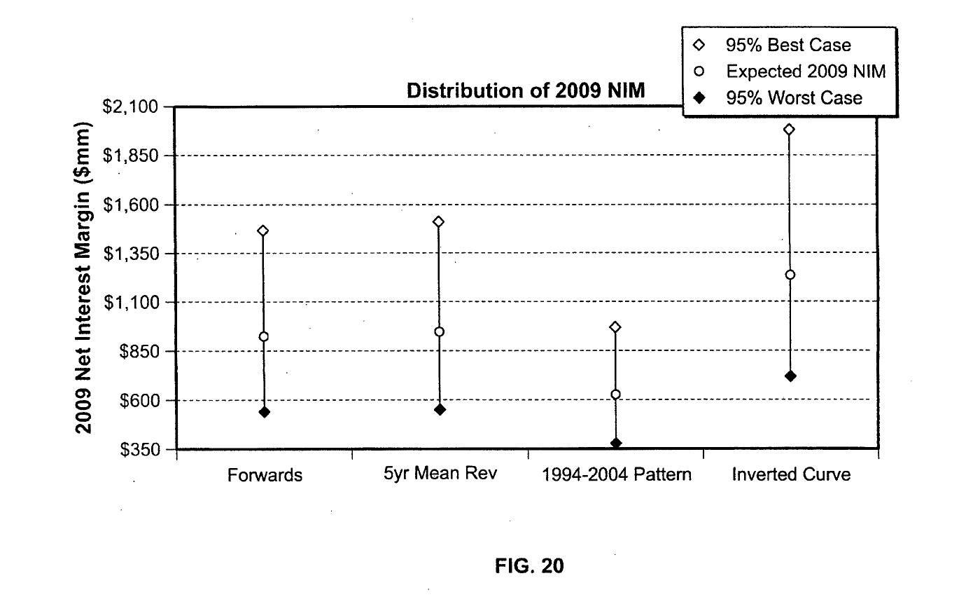

FIGS. 19-20 illustrate distribution of 2009 NIM over time for various scenarios. TABLE 6 lists summary 2009 statistics.

TABLE 6
Summary Statistics

| | Scenario | | | | |
|---|---|---|---|---|---|
| | | | 5 yr Mean | 1994-2004 | Inverted |
| | ($ mm) | Forwards | Rev | Pattern | Curve |
| Expected 2009 | | $924 | $946 | $620 | $1,234 |
| NIM | | | | | |
| 95% Best Case | | $1,465 | $1,511 | $961 | $1,973 |
| 95% Worst Case | | $542 | $551 | $373 | $716 |
| Std. Dev. | | $293 | $304 | $188 | $395 |
| 95% Value-at-Risk | | $381 | $395 | $247 | $518 |
| (VaR) | | | | | |

### Blended Scenario

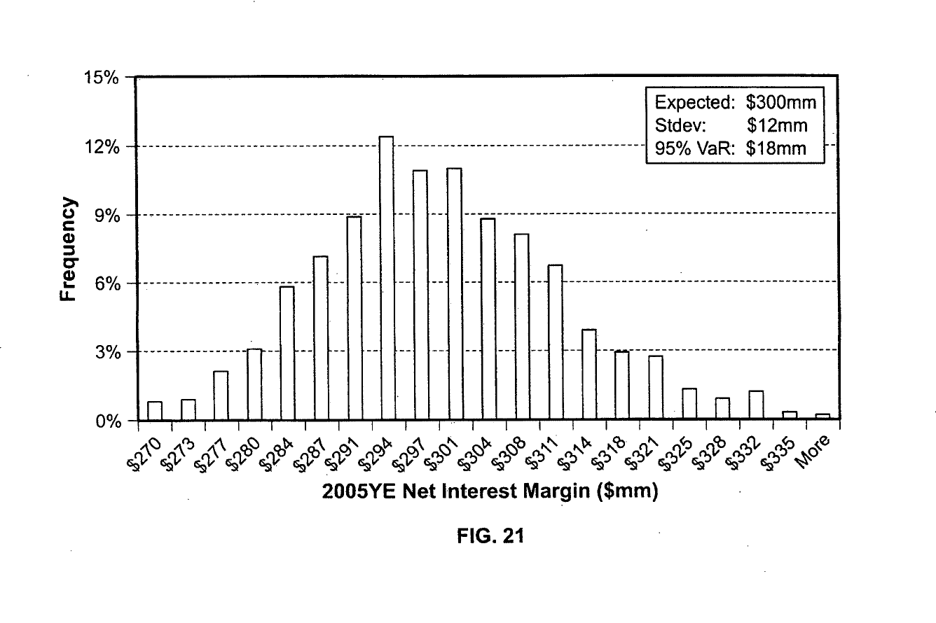

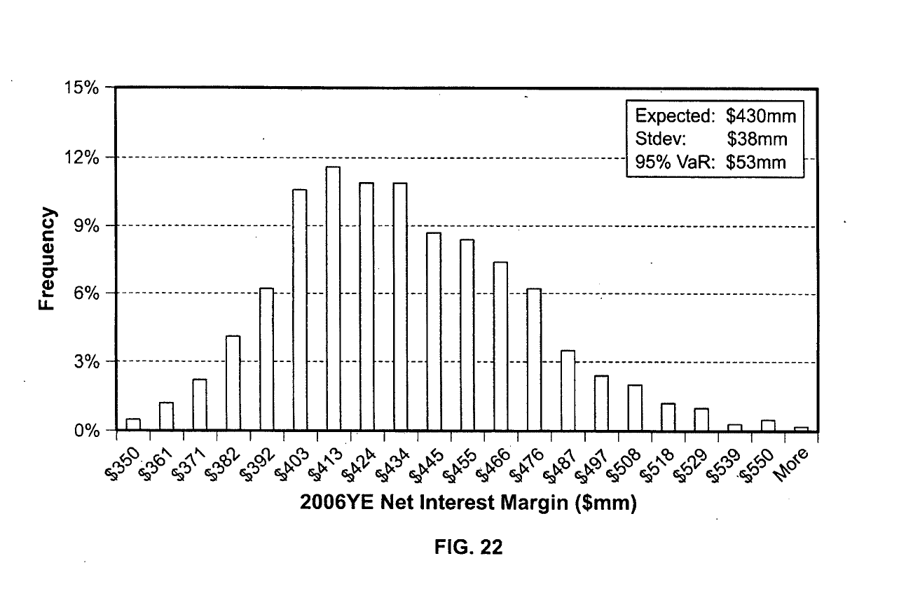

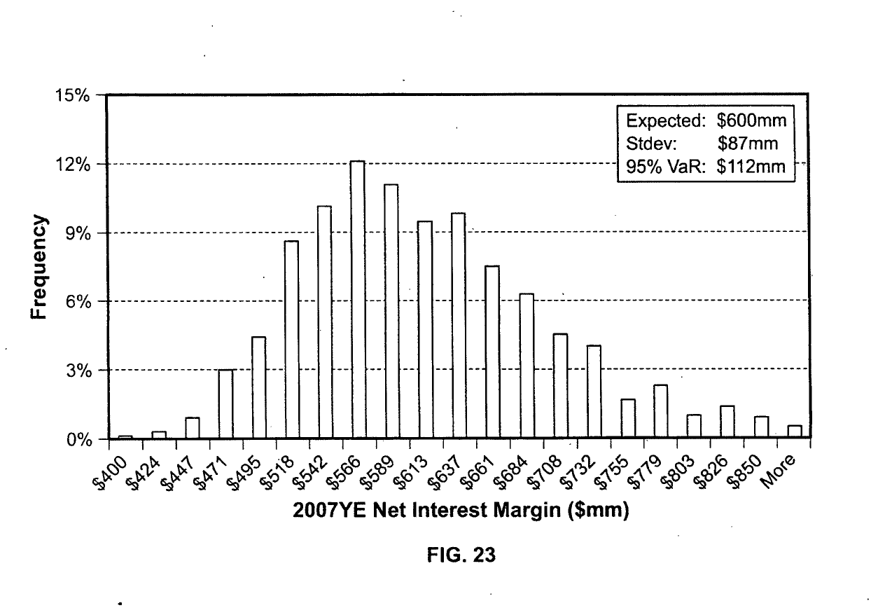

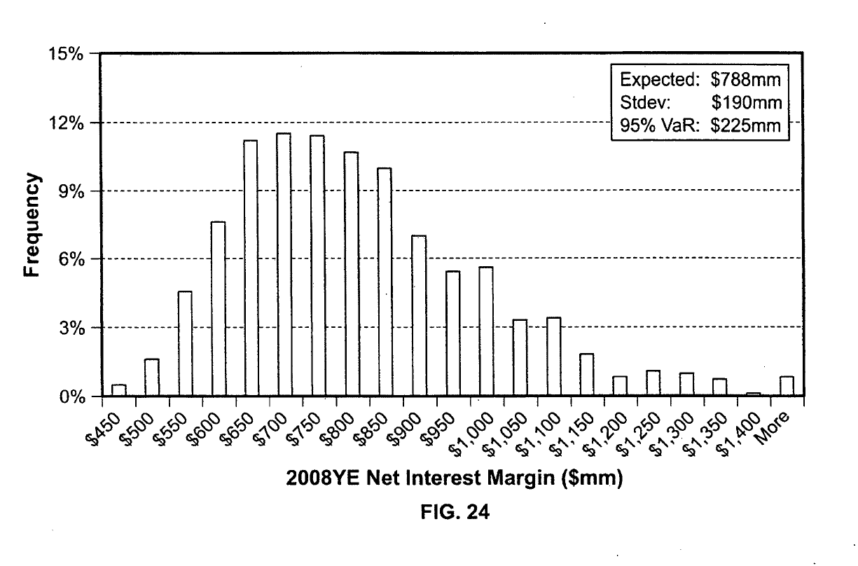

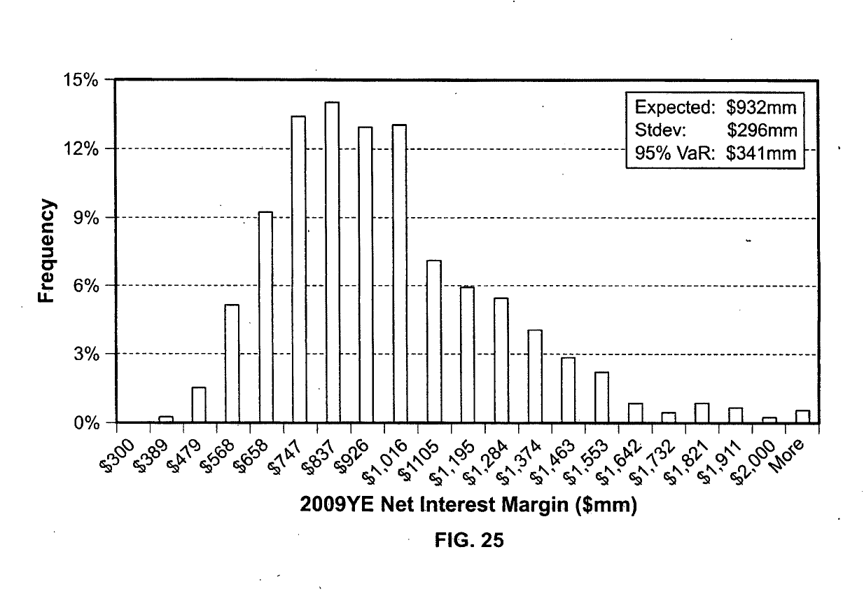

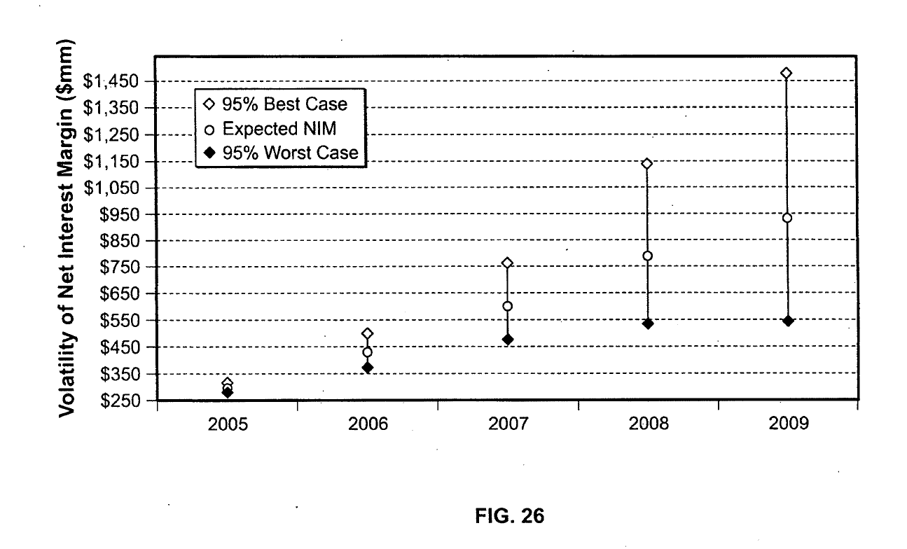

FIGS. 21-26 illustrate results of a blended scenario (33% scenario 1+33% scenario 2+17 scenario 3+17% scenario 4). TABLE 7 lists summary statistics.

TABLE 7

| Summary | | | | | | |
|---|---|---|---|---|---|---|
| Statistics | ($mm) | 2005 | 2006 | 2007 | 2008 | 2009 |
| Expected NIM | | $298 | $430 | $600 | $788 | $932 |
| 95% Best Case | | $319 | $498 | $762 | $1,140 | $1,480 |
| 95% Worst Case | | $278 | $373 | $476 | $535 | $546 |
| Std. Dev. | | $12 | $38 | $87 | $190 | $296 |
| 95% Value-at-Risk | | $19 | $57 | $123 | $253 | $386 |
| (VaR) | | | | | | |

Dual Swap Strategy Impact on NIM

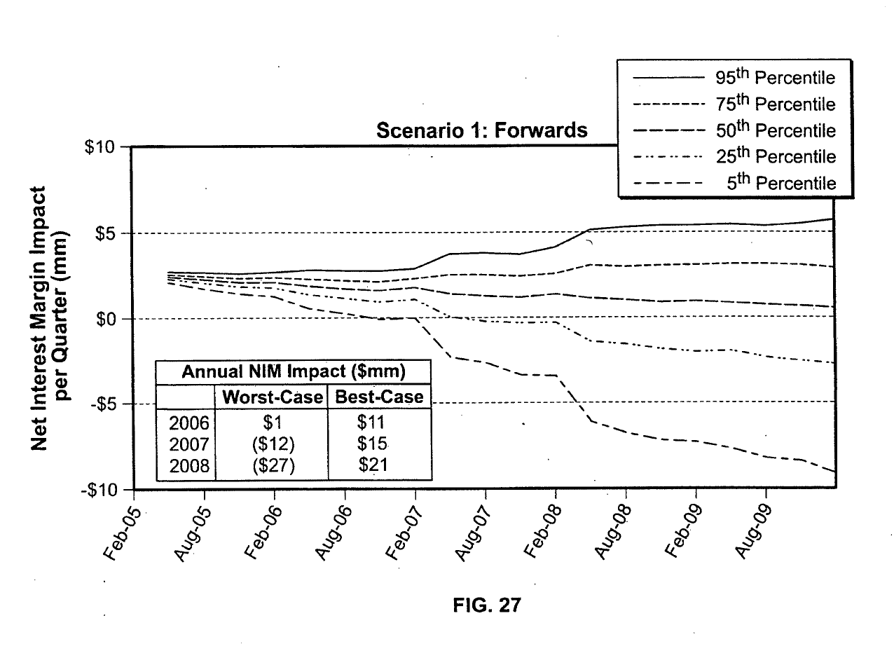

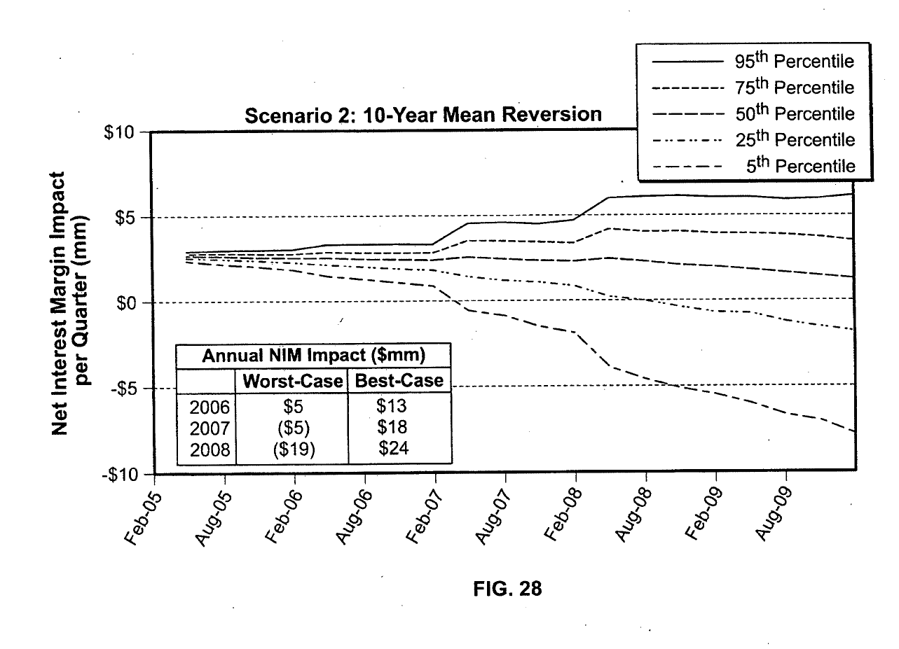

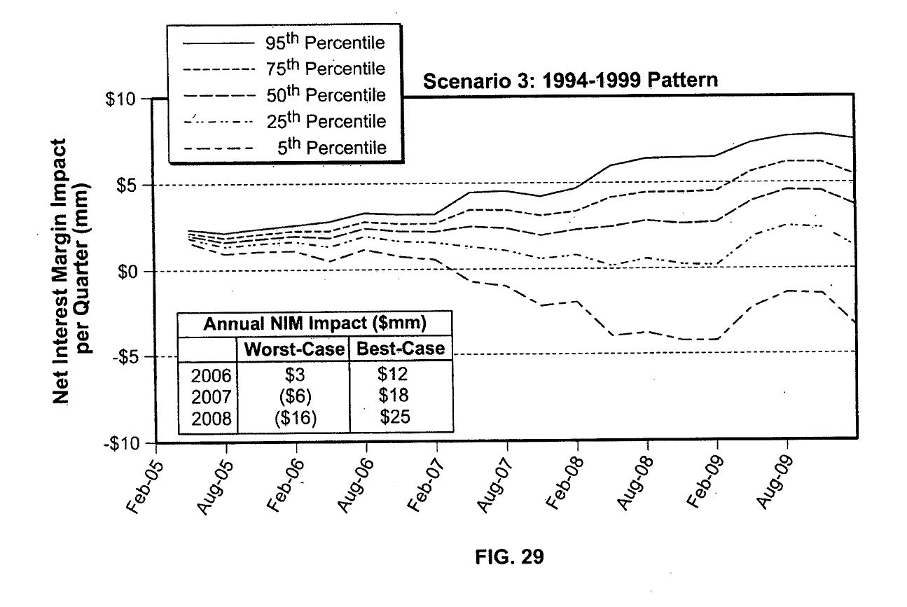

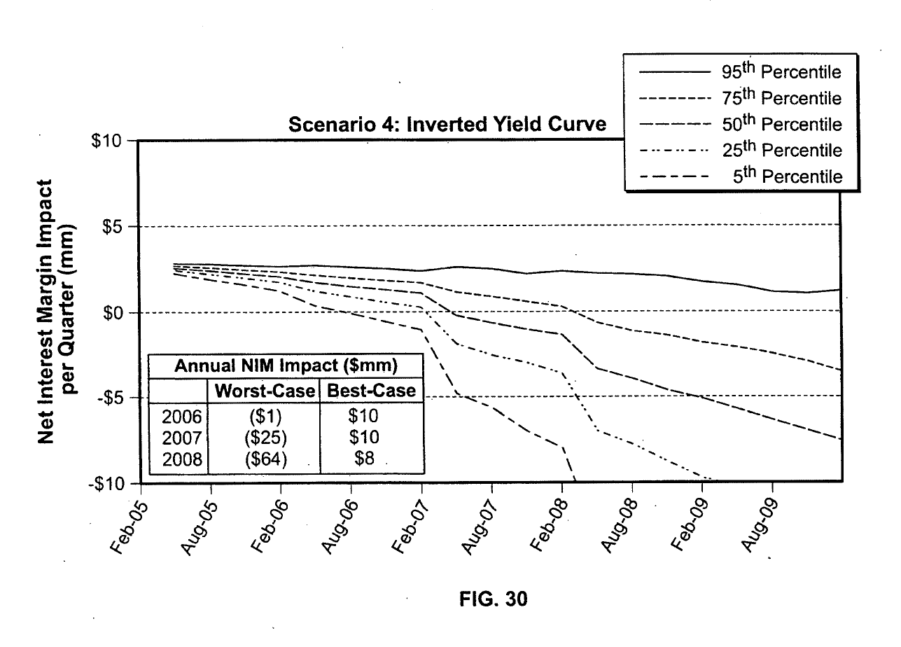

In a majority of the outcomes for the scenarios analyzed, XYZ's portfolio is better positioned for NIM gains after execution of a dual swap strategy. See FIGS. 27-30.

Dual Swap Strategy vs. Doing Nothing—YE 2005

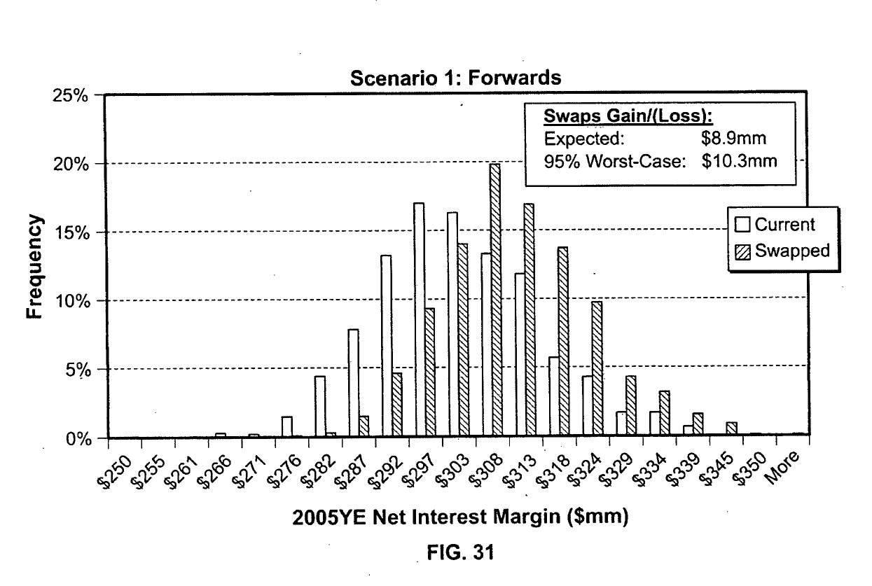

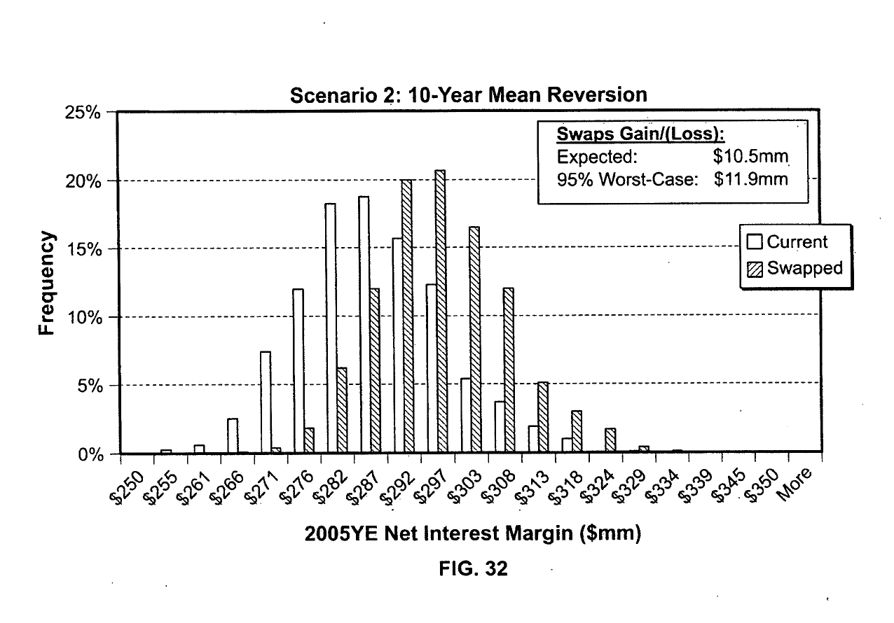

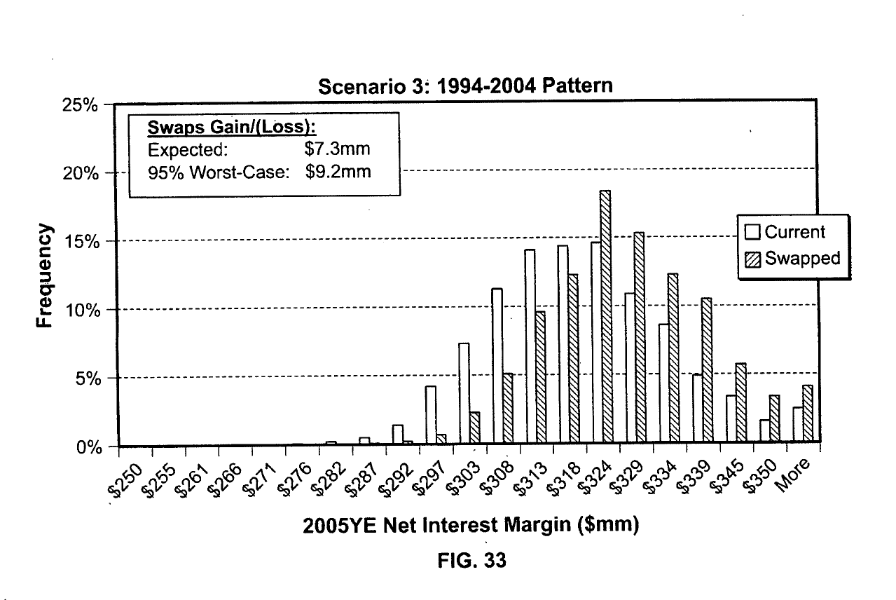

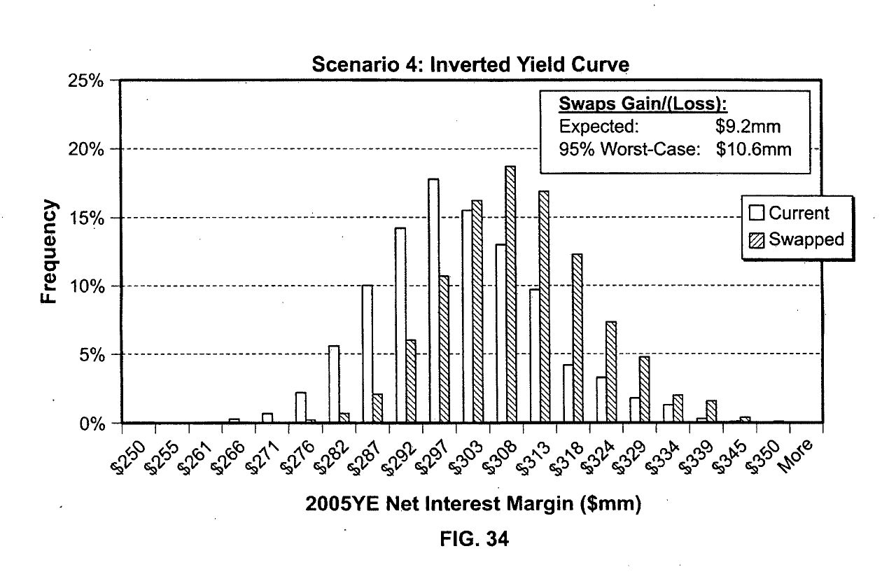

FIGS. 31-34 provide a comparison of results for doing nothing (“current”) versus “swapped” for 2005.

Dual Swap Strategy vs. Doing Nothing—YE 2006

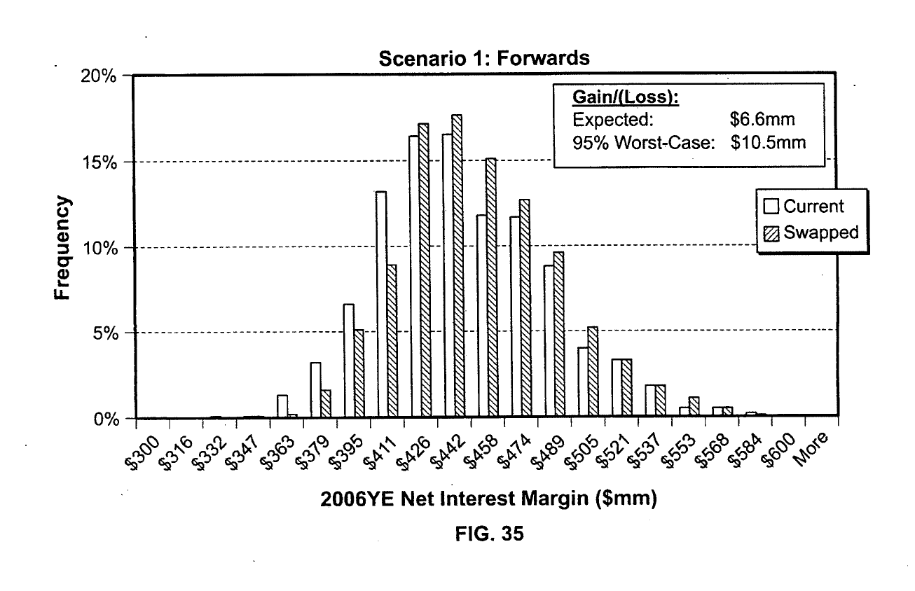

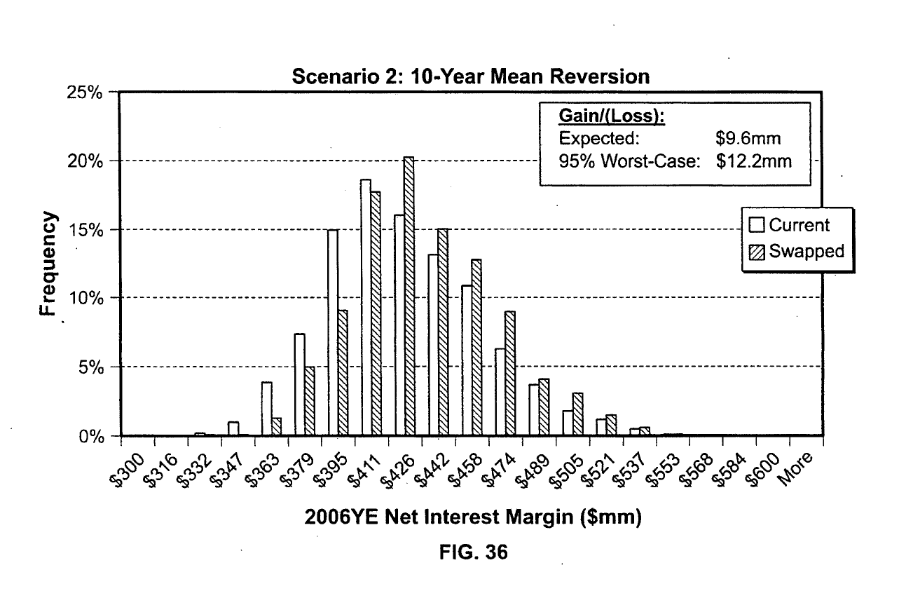

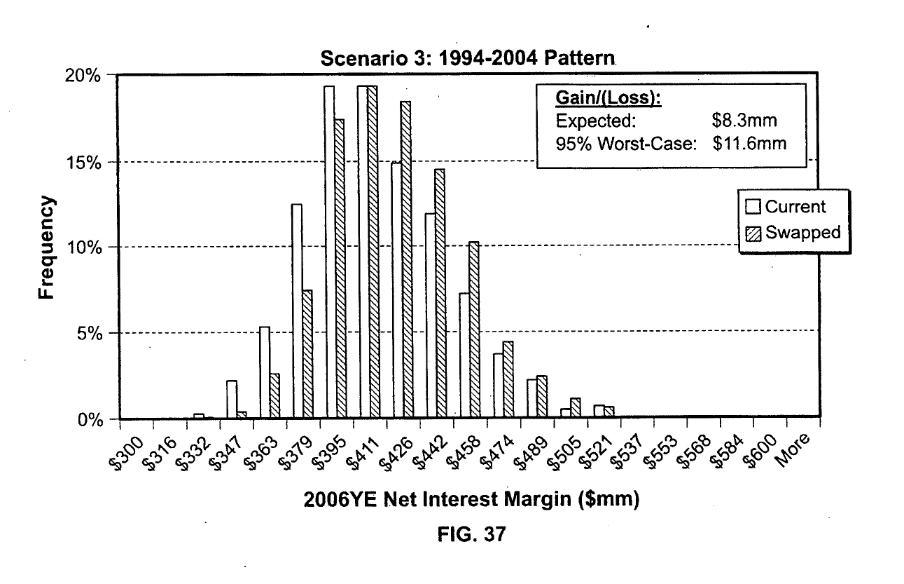

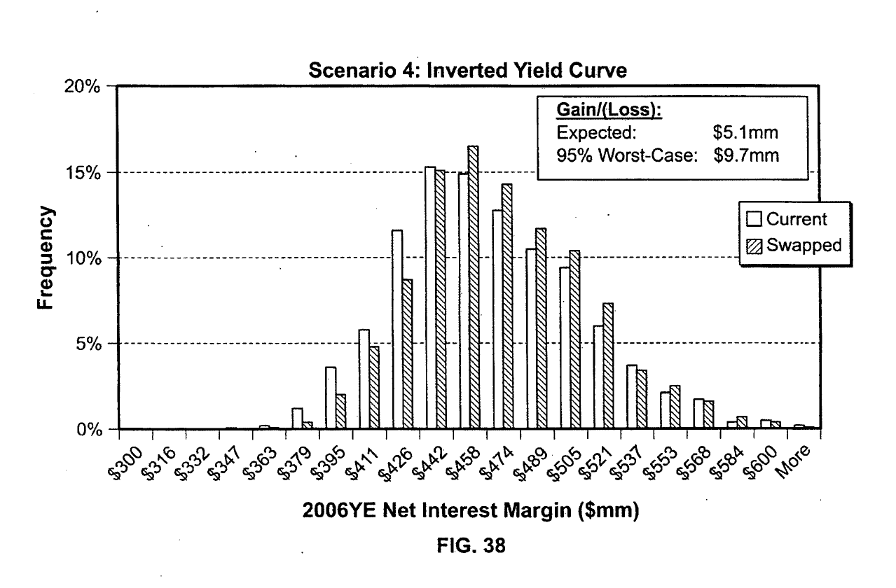

FIGS. 35-38 provide a comparison of results for doing nothing (“current”) versus “swapped” for 2006.

Dual Swap Strategy vs. Doing Nothing—YE 2007

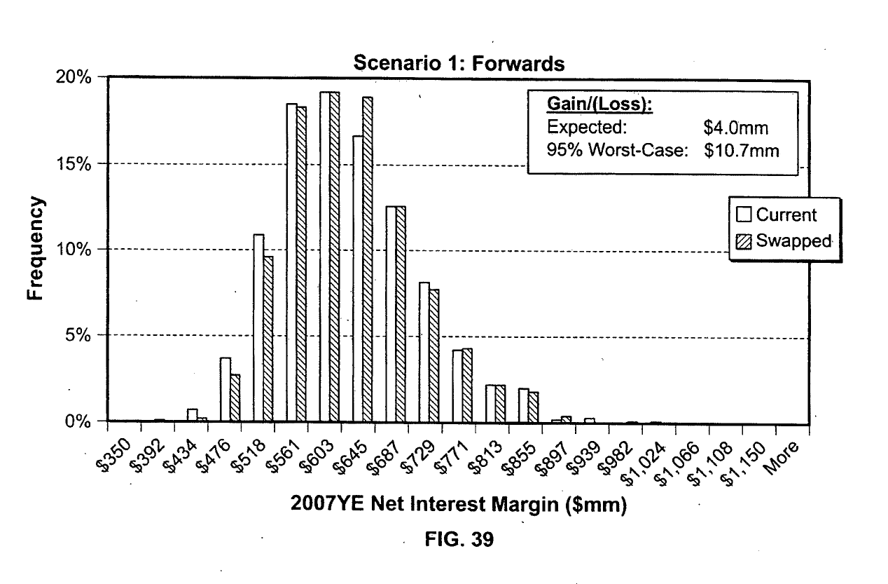

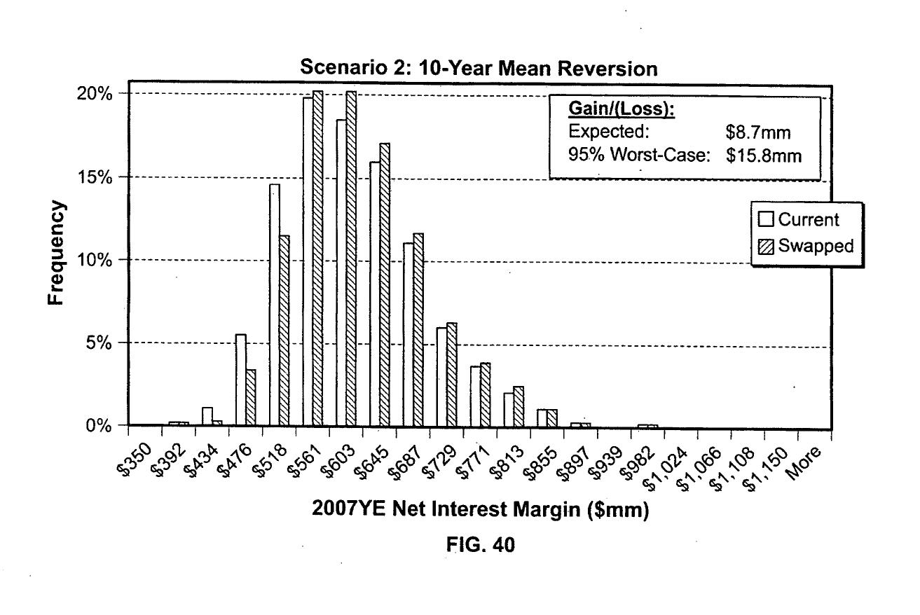

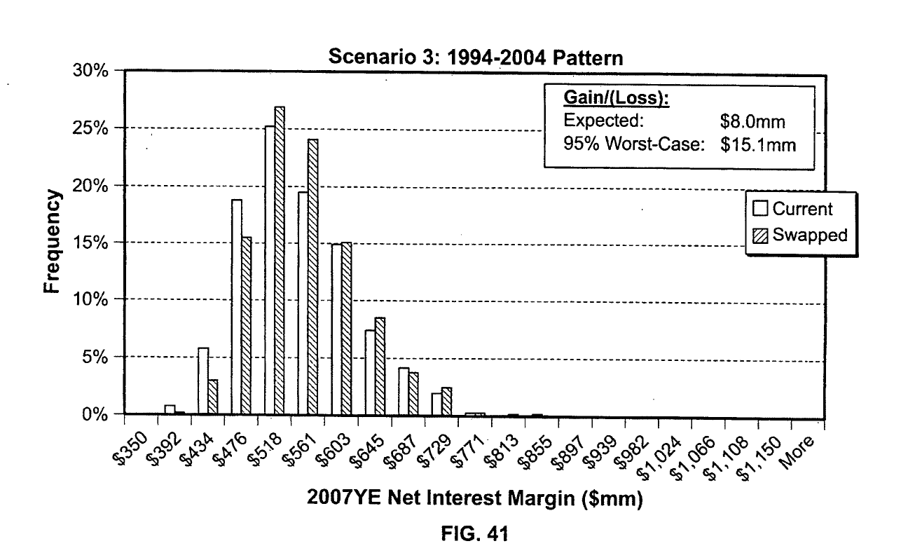

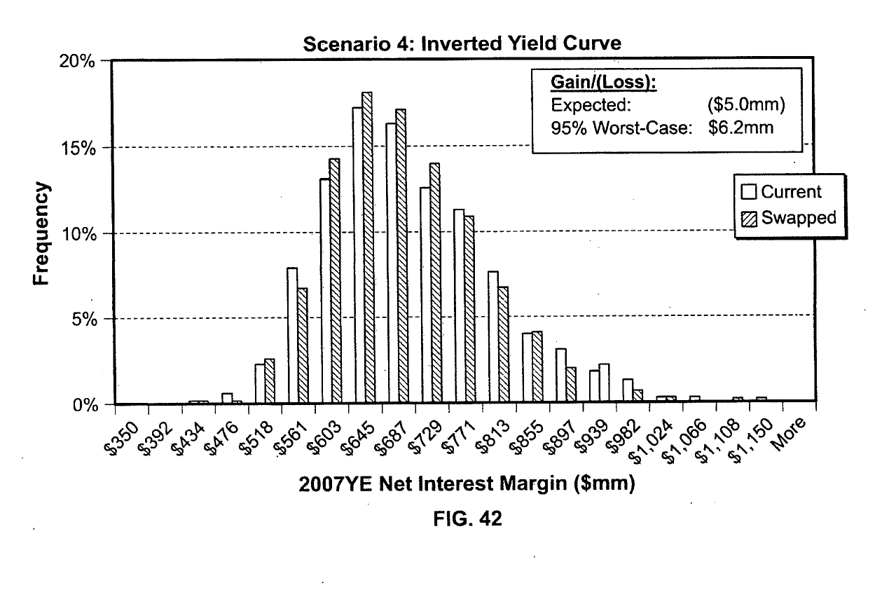

FIGS. 39-42 provide a comparison of results for doing nothing (“current”) versus “swapped” for 2007.

Dual Swap Strategy vs. Doing Nothing—YE 2008

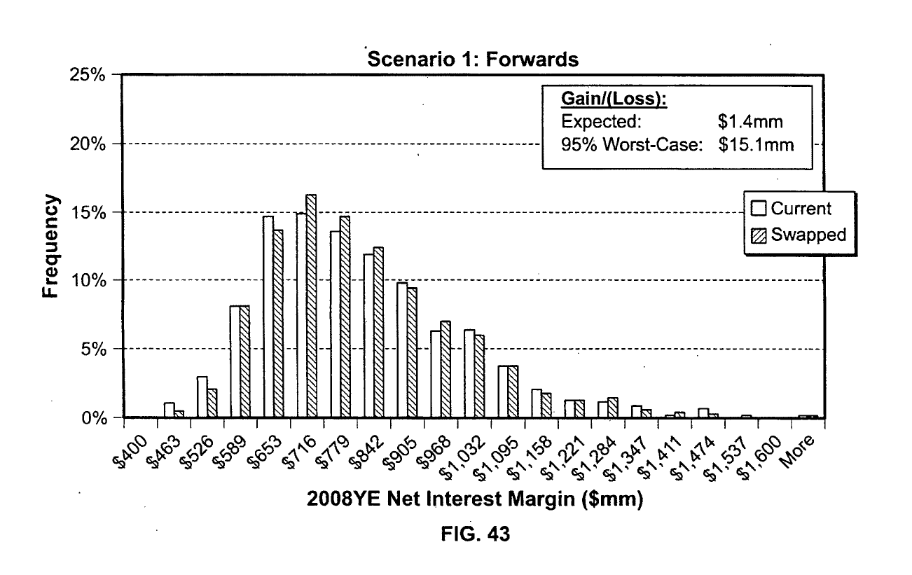

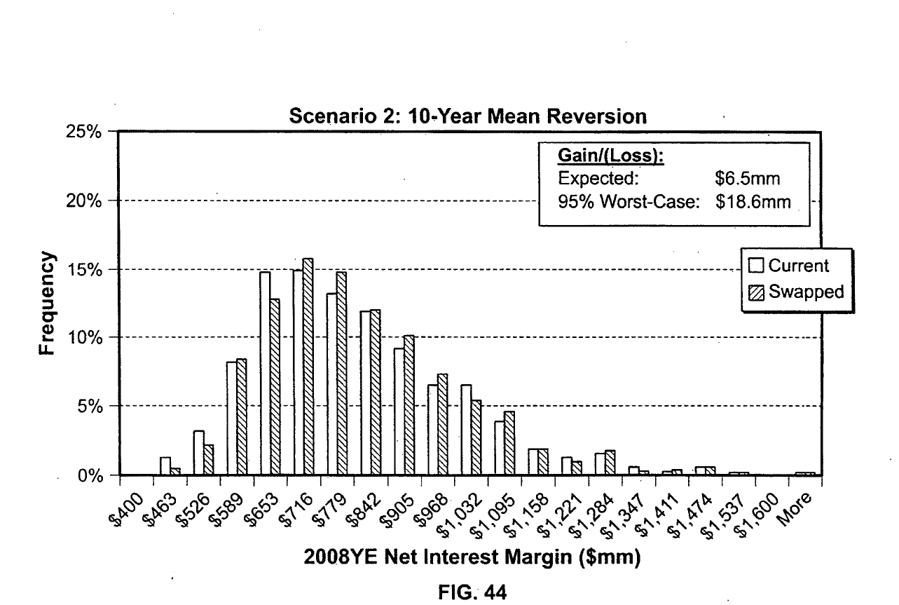

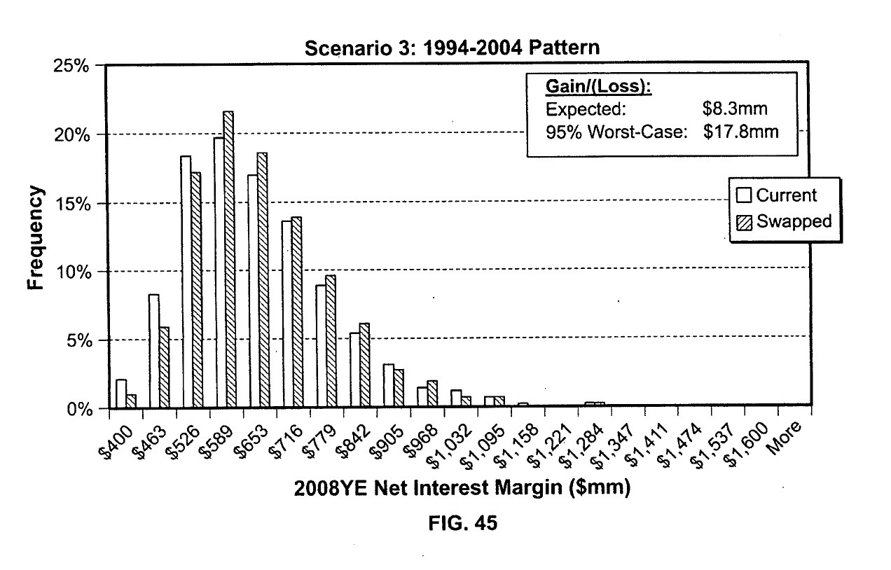

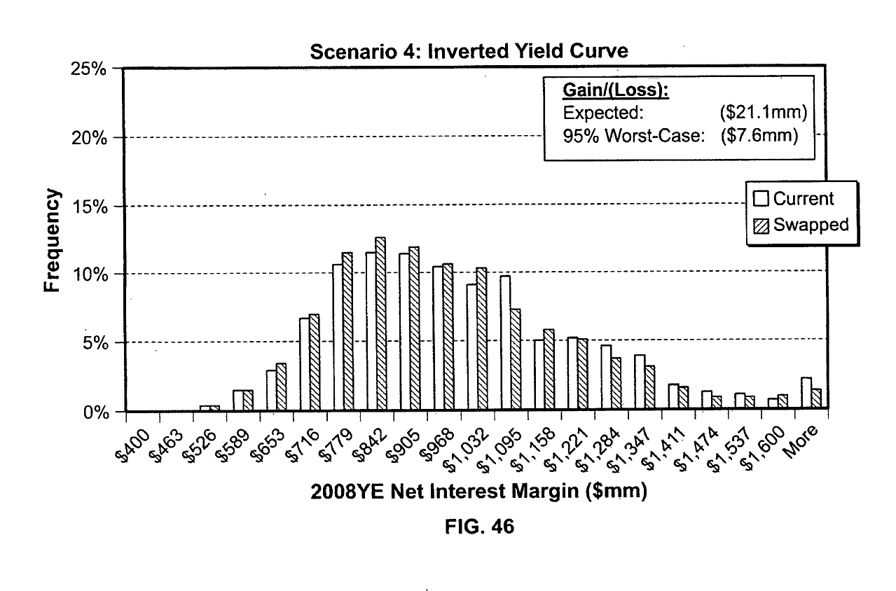

FIGS. 43-46 provide a comparison of results for doing nothing (“current”) versus “swapped” for 2008.

Dual Swap Strategy vs. Doing Nothing—YE 2009

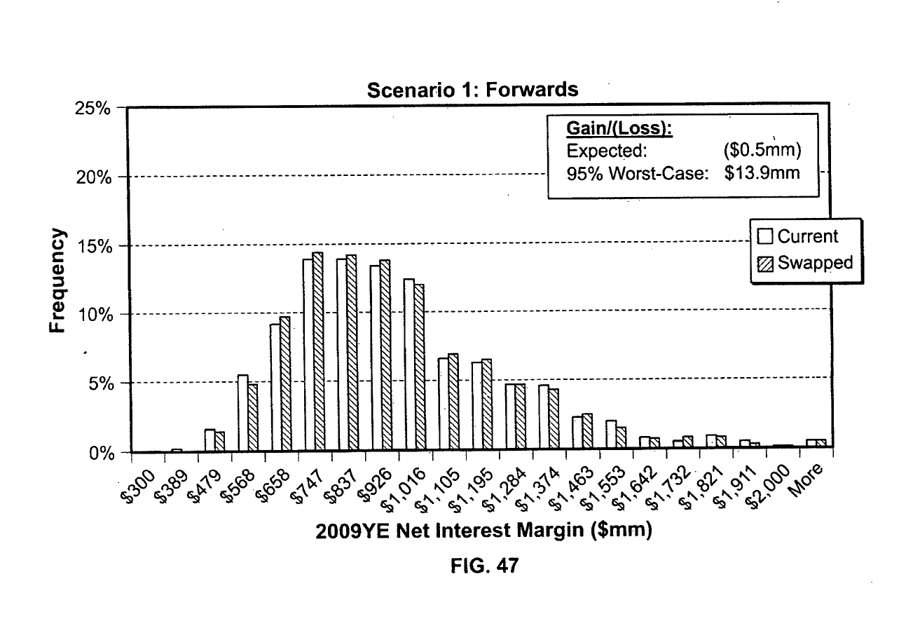

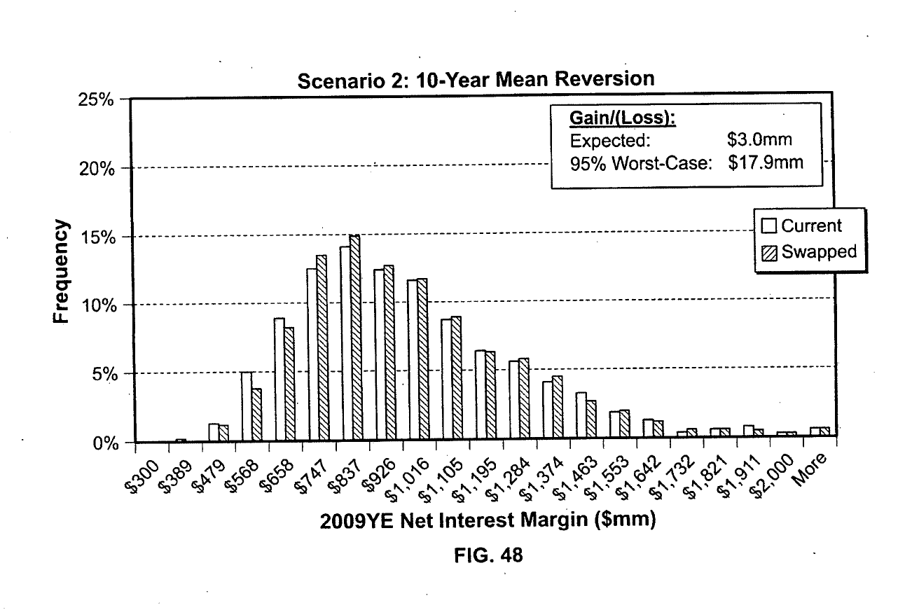

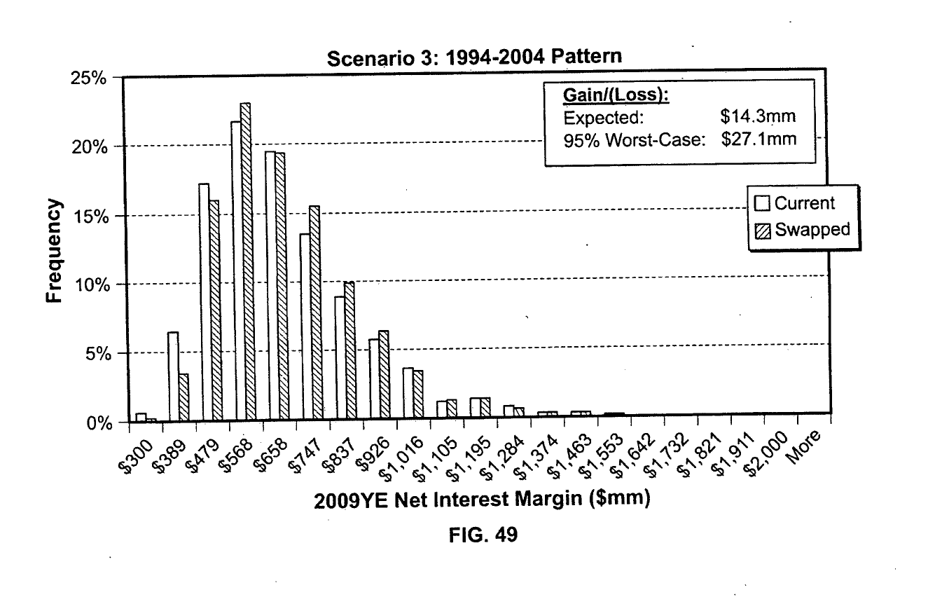

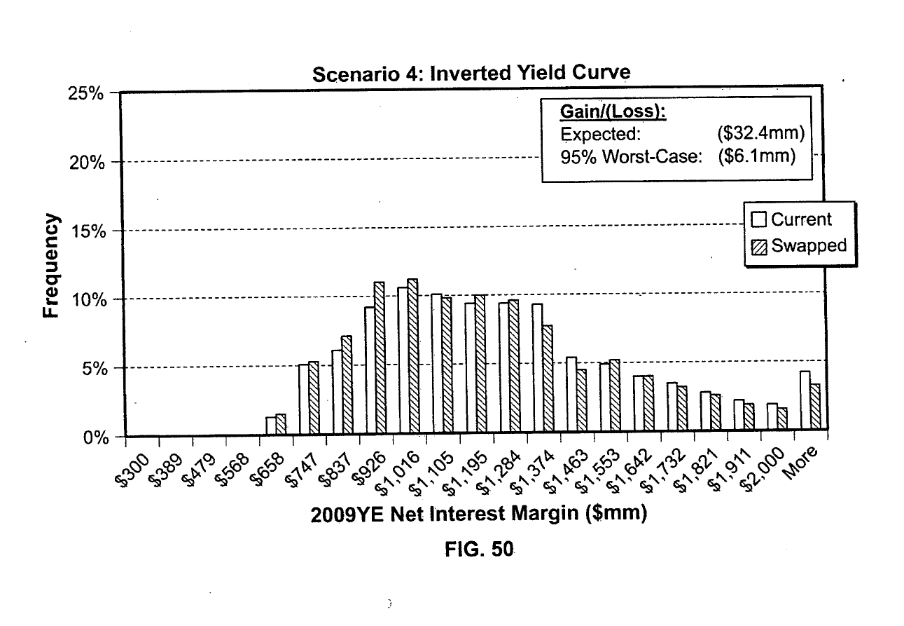

FIGS. 47-50 provide a comparison of results for doing nothing (“current”) versus “swapped” for 2009.

A second example describes preferred treatment of company “ABC,” and illustrates preferred operation of a “fixed/floating decision framework.”

In this example, IRSF generates a plurality of future interest rate paths to calculate a range of interest expense levels produced by ABC's current interest rate sensitive liability portfolio.

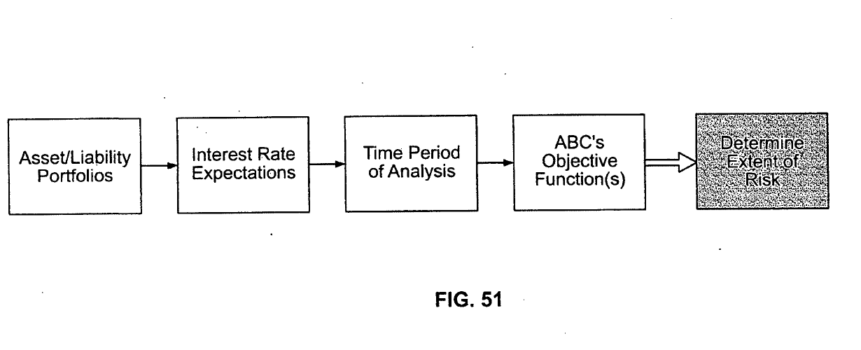

Our analysis is driven by the following assumptions (see FIG. 51):

Assumptions regarding asset/liability portfolios: duration; coupons; maturities; for liabilities, payment schedule and refinancing assumptions; and for assets, reinvestment assumptions.

Assumptions regarding interest rate expectations: expected future levels; speed of adjustment to future levels; and interest rate volatility and correlations.

Assumptions regarding time period of analysis: 6 years, 7 months.

Assumptions regarding ABC's objective functions: maximize expected Interest Expense (“IE”); minimize volatility of IE; and minimize volatility of IE without compromising lower IE.

Assumptions regarding determination of extent of risk: how much floating-rate exposure ABC can take before compromising its objective functions; and how much risk ABC is willing to take.

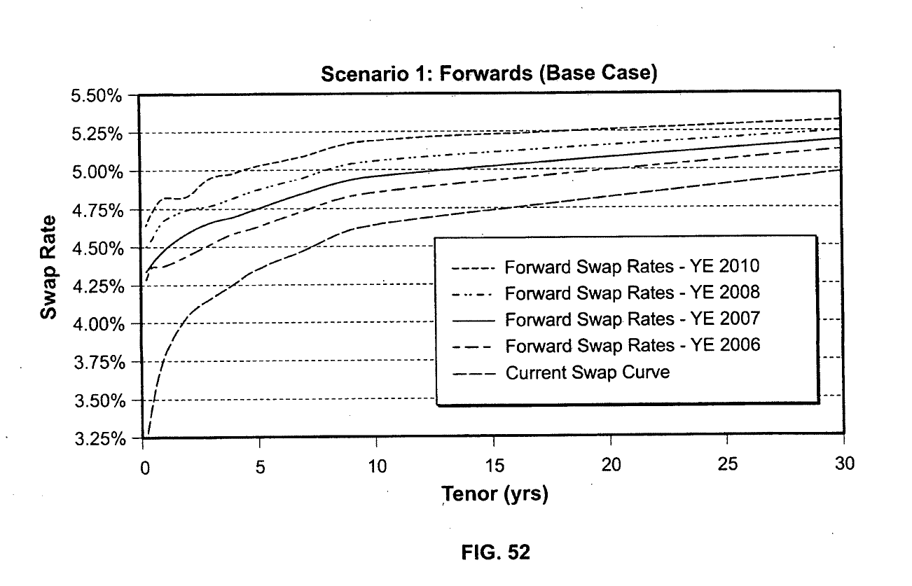

FIGS. 52-55 depict swap rates over time for various interest rate scenario assumptions. ABC″S IE is analyzed assuming different interest rate scenarios.

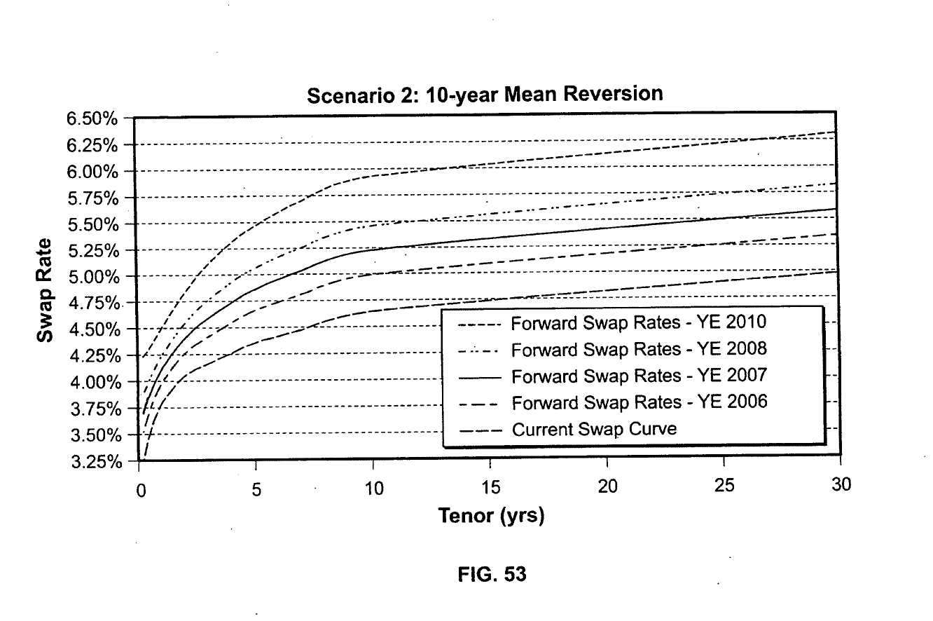

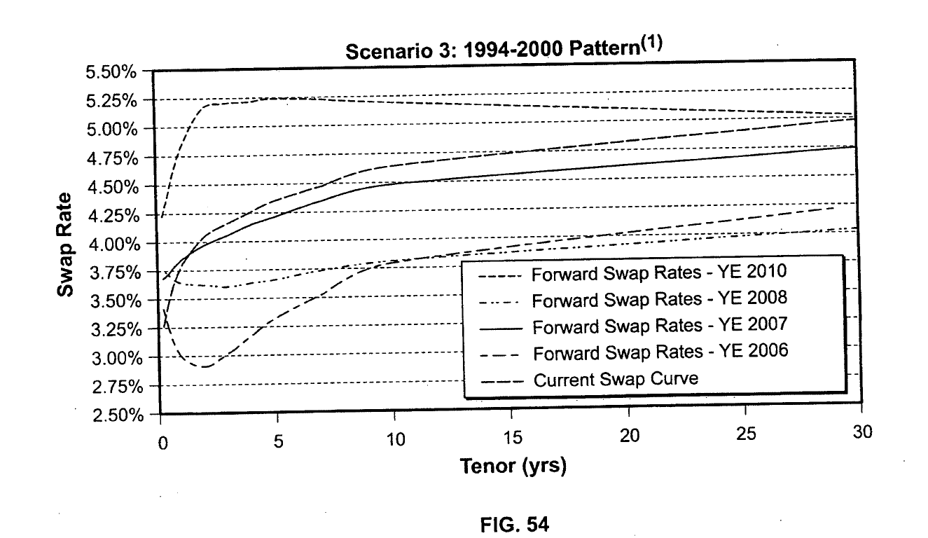

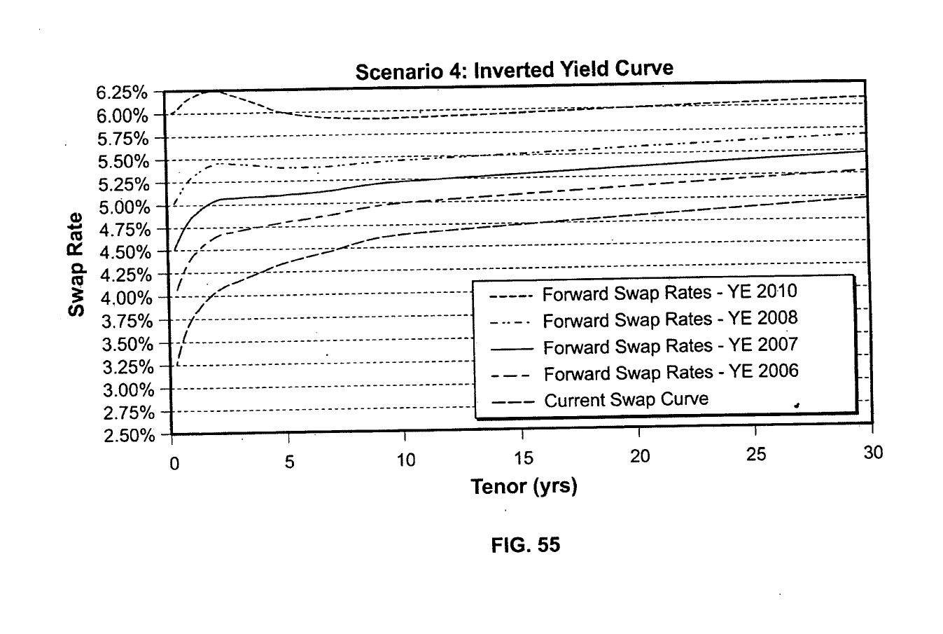

FIG. 52 depicts a base case (“forwards”); FIG. 53 illustrates a 10-year mean reversion case; FIG. 54 illustrates a 1994-1999 pattern case; and FIG. 55 illustrates an inverted yield curve case.

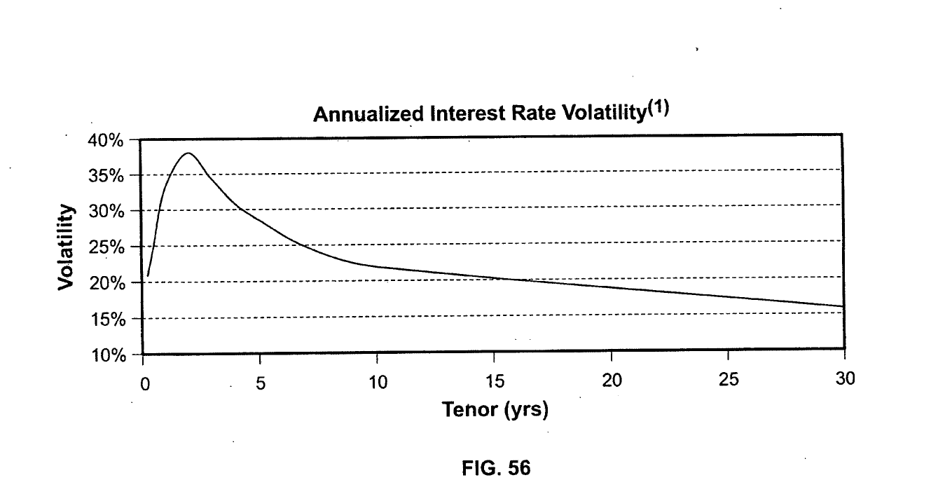

Based on interest rate movements over the past 10 years, we estimate that future interest rates move to their expected values using the interest rate volatilities and correlations shown in FIG. 56 and TABLE 8.

TABLE 8
Correlations (1999-2004)

| | 3 m | 6 m | 1yr | 2 yr | 3 yr | 4 yr | 5 yr | 7 yr | 10 yr | 30 yr |
|---|---|---|---|---|---|---|---|---|---|---|
| 3 m | 100% | 89% | 69% | 39% | 35% | 33% | 32% | 31% | 29% | 23% |
| 6 m | 89% | 100% | 90% | 56% | 52% | 49% | 48% | 46% | 43% | 35% |
| 1 yr | 69% | 90% | 100% | 69% | 67% | 63% | 61% | 59% | 55% | 46% |
| 2 yr | 39% | 56% | 69% | 100% | 98% | 95% | 93% | 90% | 84% | 72% |
| 3 yr | 35% | 52% | 67% | 98% | 100% | 99% | 97% | 95% | 90% | 79% |
| 4 yr | 33% | 49% | 63% | 95% | 99% | 100% | 99% | 97% | 93% | 83% |
| 5 yr | 32% | 48% | 61% | 93% | 97% | 99% | 100% | 99% | 95% | 86% |
| 7 yr | 31% | 46% | 59% | 90% | 95% | 97% | 99% | 100% | 98% | 90% |
| 10 yr | 29% | 43% | 55% | 84% | 90% | 93% | 95% | 98% | 100% | 93% |
| 30 yr | 23% | 35% | 46% | 72% | 79% | 83% | 86% | 90% | 93% | 100% |

Monte Carlo Simulation

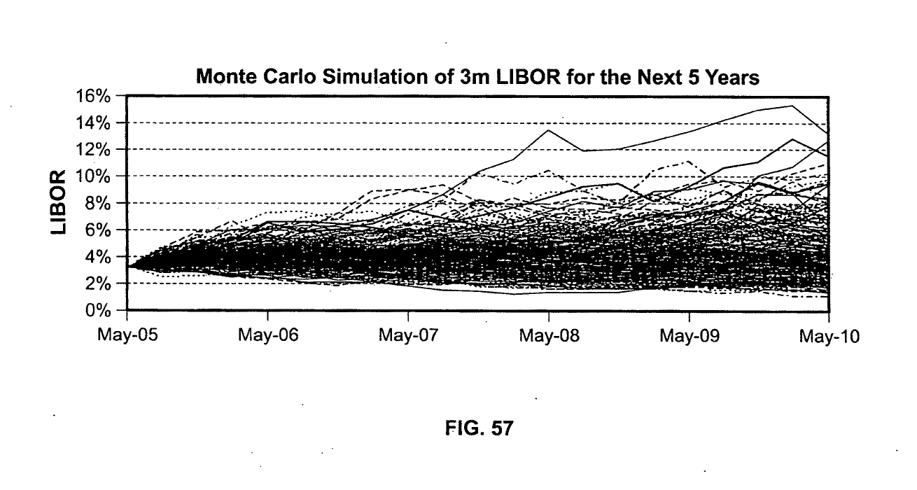

The Monte Carlo simulation shown in FIG. 57 represents 1000 potential paths for 3 m LIBOR for the next five years based on the forward curve and historical volatility. The average of these distributions represents the expected outcome, which in this case would be the forward curve scenario.

Current IE Projections—5% Floating

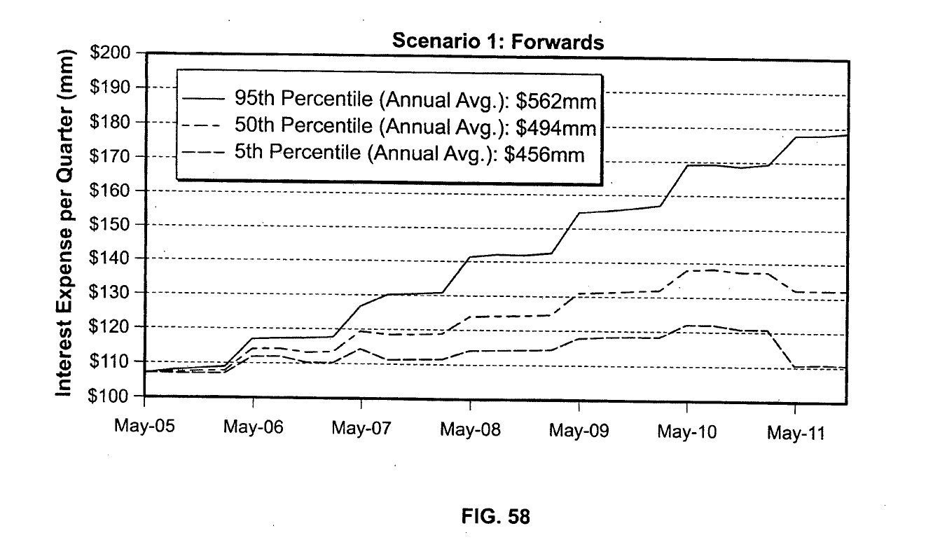

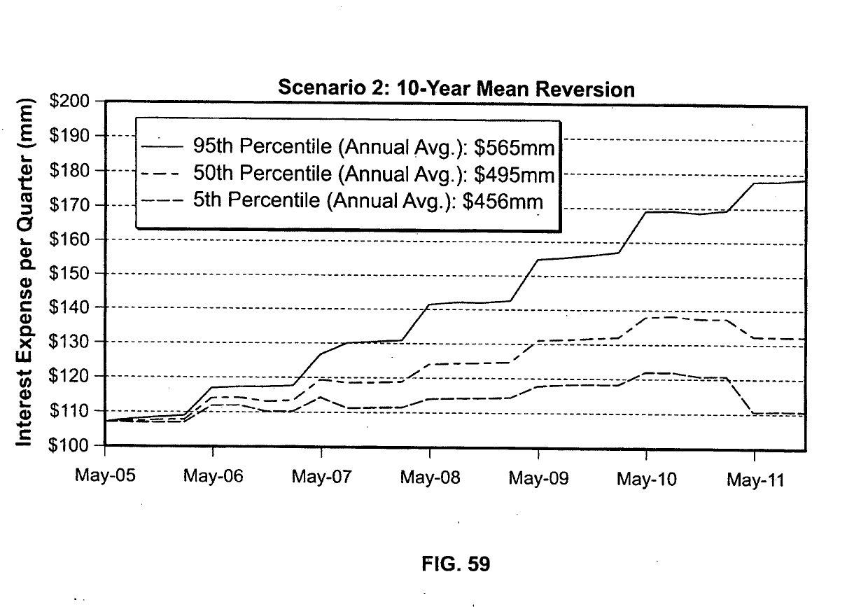

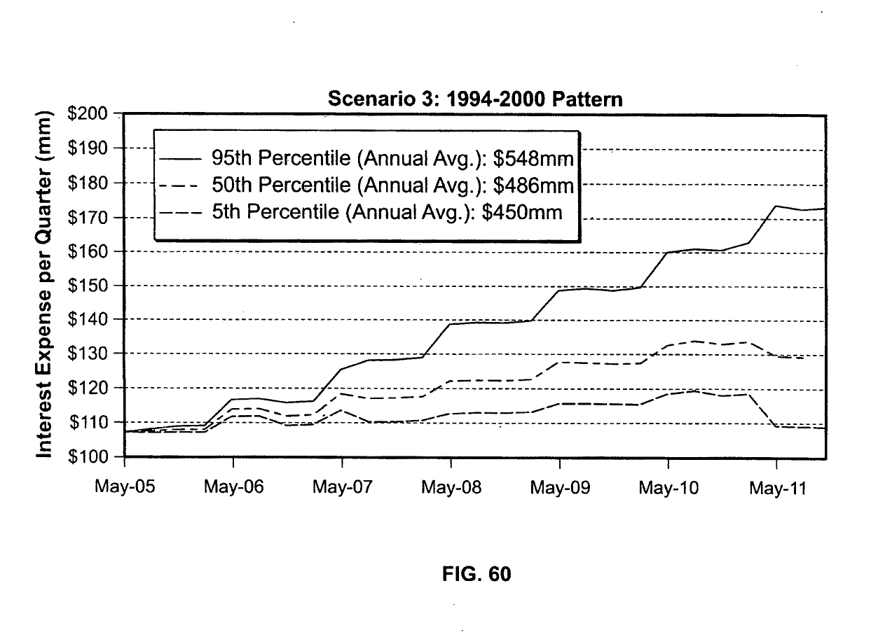

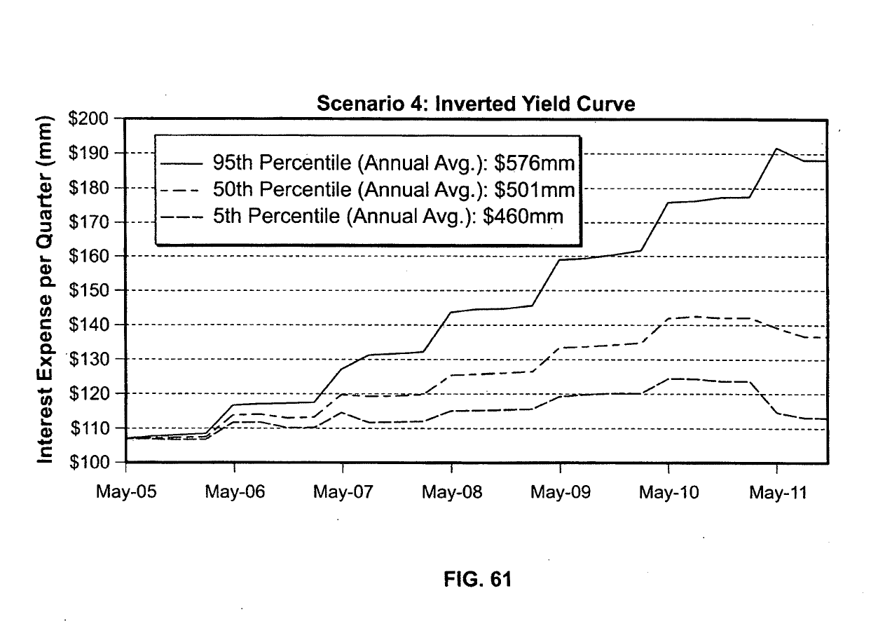

On average ABC is expected to realize $486-501 million in IE per year across all four scenarios (see FIGS. 58-61).

Observations

Interest expense growth is primarily explained by higher leverage on a pro-form a basis due to $500 million of new fixed rate debt issued annually and 15% annual increase in current portfolio (“CP”) balance. The similarity of median interest expense and VaR results across all four scenarios is explained by: (a) relatively small percentage of fixed rate re-pricings over analysis horizon (29% of ABC's fixed rate debt re-prices by the end of 2011), and (b) minimal amount of floating rate debt in the capital structure over the analysis horizon (floating rate percentages decline over time, since pro form a assumptions reflect more fixed rate debt being added to the capital structure relative to CP).

While there are differences in the risk distribution of interest expense across rate scenarios, the amounts are insignificant in the context of ABC's overall interest expense.

Interest Rate Simulation Results: Swap Scenarios

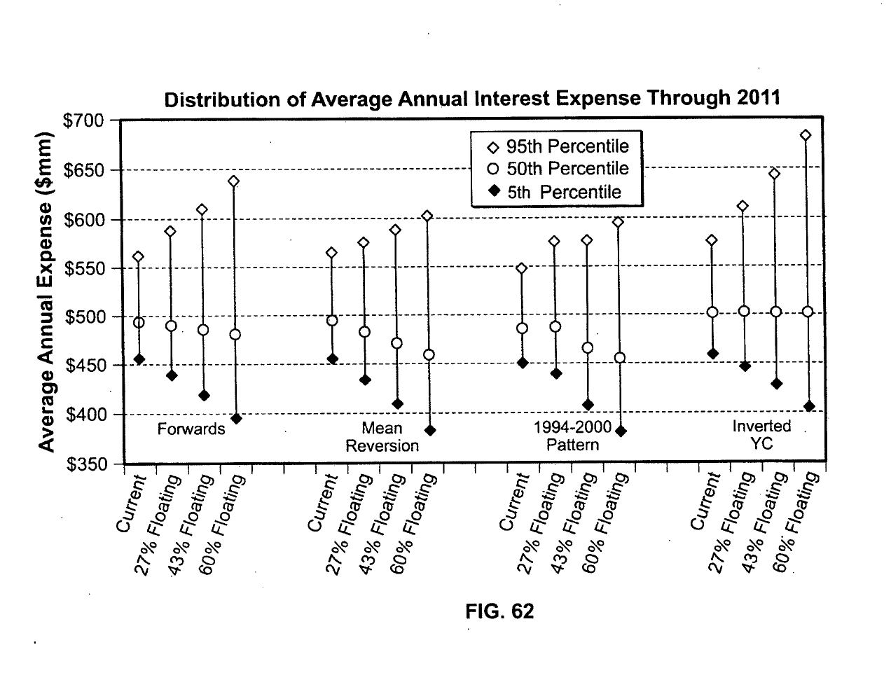

FIG. 62 depicts essentially the same data as listed in TABLE 9. But the display in FIG. 62 presents the data much more advantageously, allowing a viewer to see, all one page, various probability distributions for a plurality of swap scenarios (current, 23% floating, etc.) and interest rate scenarios (forwards, mean reversion, etc.). The same display also can be used for other products (e.g., caps or collars) to show how the products impact a risk profile.

For example, a viewer can easily see that an inverted yield curve scenario presents the greatest financial risk to ABC, and that, at 27% floating, ABC does not materially increase its Value at Risk (“VaR”) in 3 out of 4 scenarios. Furthermore, a viewer can easily see the expected reduction in annual interest expense and visually compare this expected reduction to the expected increase in VaR risk.

Generally, the chart depicted in FIG. 62 may comprise, for each interest rate scenario, one or more vertical bars corresponding to a risk management product scenario, and the risk management product scenario may be for one or more of: swaps, collars, caps, floors, swaptions, and forward starting swaps, and other risk management products.

TABLE 9

| | Forwards | | | | Mean Reversion | | | | 1994-2000 Pattern | | | | Inverted YC | | | |
|---|---|---|---|---|---|---|---|---|---|---|---|---|---|---|---|---|
| Summary | | 27% | 43% | 60% | | 27% | 43% | 60% | | 27% | 43% | 60% | | 27% | 43% | 60% |
| Statistics | | Float- | Float- | Float- | | Float- | Float- | Float- | | Float- | Float- | Float- | | Float- | Float- | Float- |
| (mm) | current | ing | ing | ing | current | ing | ing | ing | current | ing | ing | ing | current | ing | ing | ing |
| 5th Percentile | $456 | $440 | $419 | $395 | $456 | $434 | $410 | $382 | $450 | $439 | $407 | $381 | $460 | $447 | $428 | $405 |
| 50th Percentile | $494 | $490 | $486 | $481 | $495 | $482 | $470 | $459 | $486 | $487 | $465 | $455 | $501 | $502 | $501 | $501 |
| 95th Percentile | $562 | $587 | $610 | $638 | $565 | $575 | $587 | $602 | $548 | $575 | $576 | $595 | $576 | $611 | $642 | $681 |
| Std. Deviation | $32 | $48 | $64 | $83 | $33 | $45 | $59 | $76 | $30 | $45 | $57 | $73 | $35 | $53 | $73 | $94 |
| 95% VaR | $63 | $87 | $112 | $141 | $65 | $84 | $104 | $128 | $58 | $80 | $100 | $126 | $69 | $97 | $126 | $162 |

TABLE 10 summarizes the rate scenarios and key takeaways for ABC.

TABLE 10

| | Scenario 1: | Scenario 2: | Scenario 3: | Scenario 4: |
|---|---|---|---|---|
| | Forwards | Mean Reversion | 1994-2000 | Curve Inversion |
| Scenario | Short Rates ↑ 175 | Parallel curve | Rapid ↑ in | Short end of |
| Recap | bps | shift 150 bps | short rates, then | the curve increases |
| | Term Rates ↑ 75 | higher over time | level off | by 50 bps per |
| | bps | | Rapid ↓ in term | annum and long |
| | Curve Flatter | | rates, then level off | end of the curve |
| | | | Curve flatter | increases by 20 bps |
| | | | | per annum |
| Key | Median interest | Median | Almost | Highest |
| Take- | expense across different | interest expense | identical to mean | amount of median |
| aways | levels of floating rate | savings are | reversion | interest expense |
| | exposure is relatively | material and | | and Value at Risk |
| | unchanged, however | standard | | |
| | standard deviation | deviation is | | |
| | increases nearly 3 times | smaller compared | | |
| | compared to current profile. | to scenarios 1 and 4 | | |

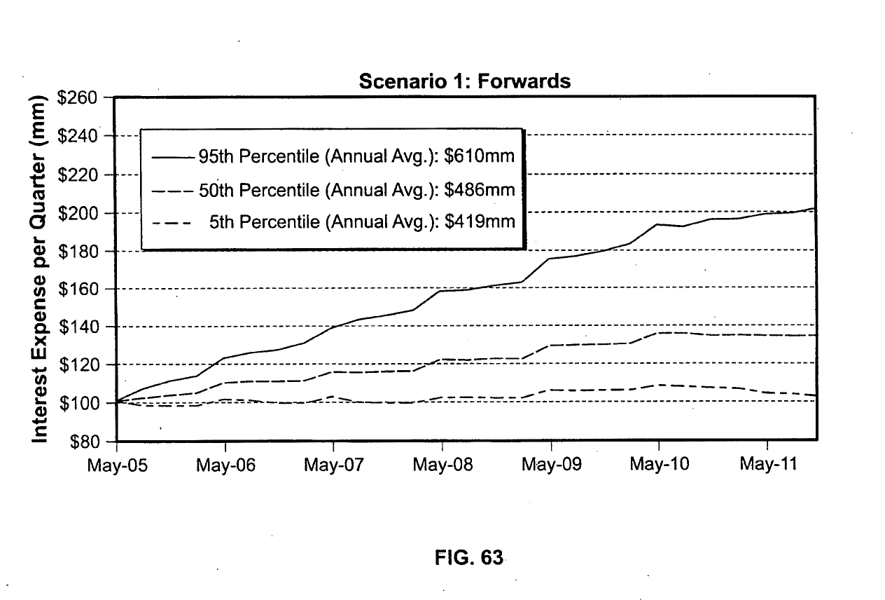

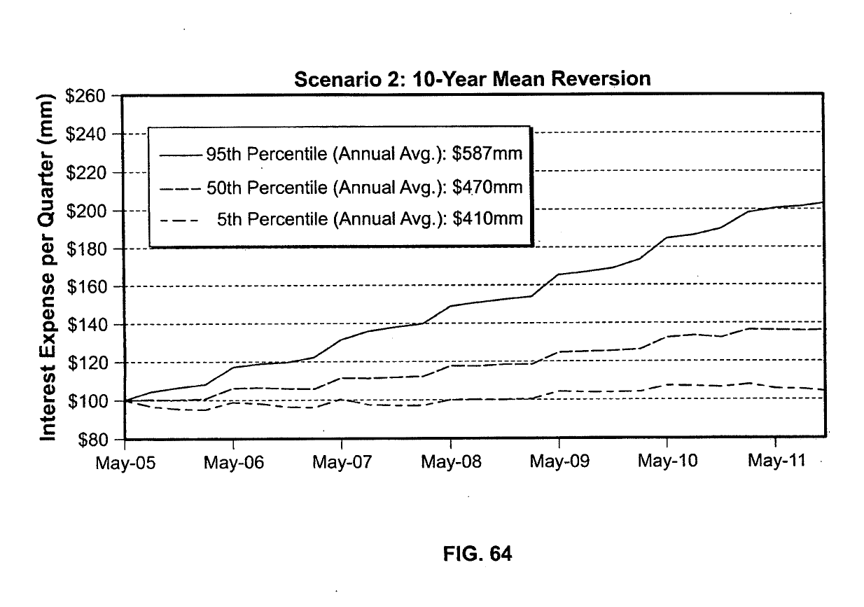

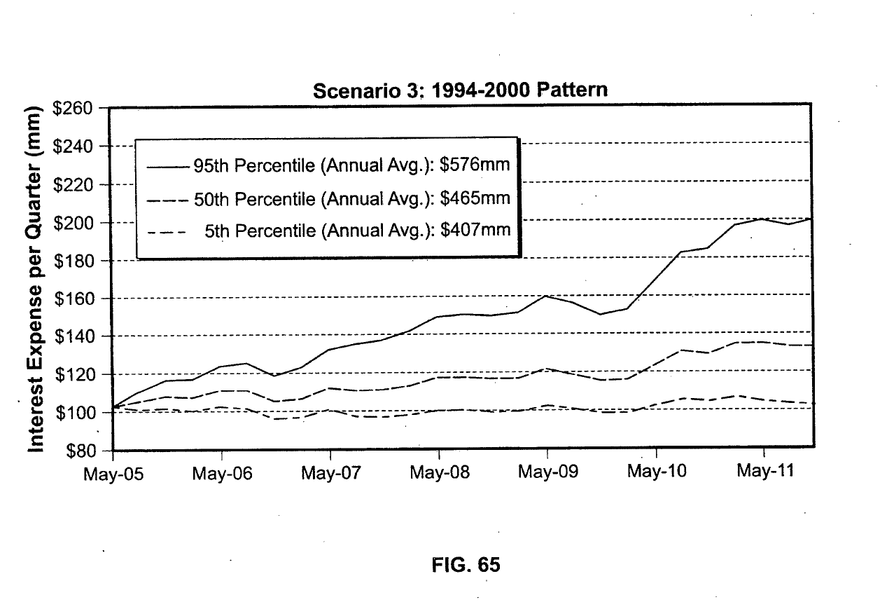

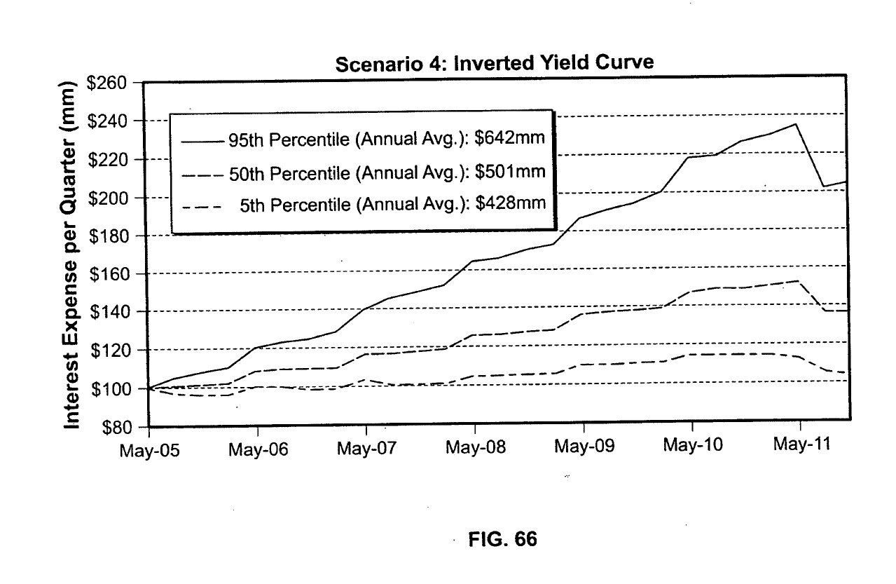

FIGS. 63-66 depict IE based on 43% floating interest rate projections. Compared to the 27% floating case, the range of median IE nearly doubles from $20 Million to $36 million, creating a range of $465-501 million.

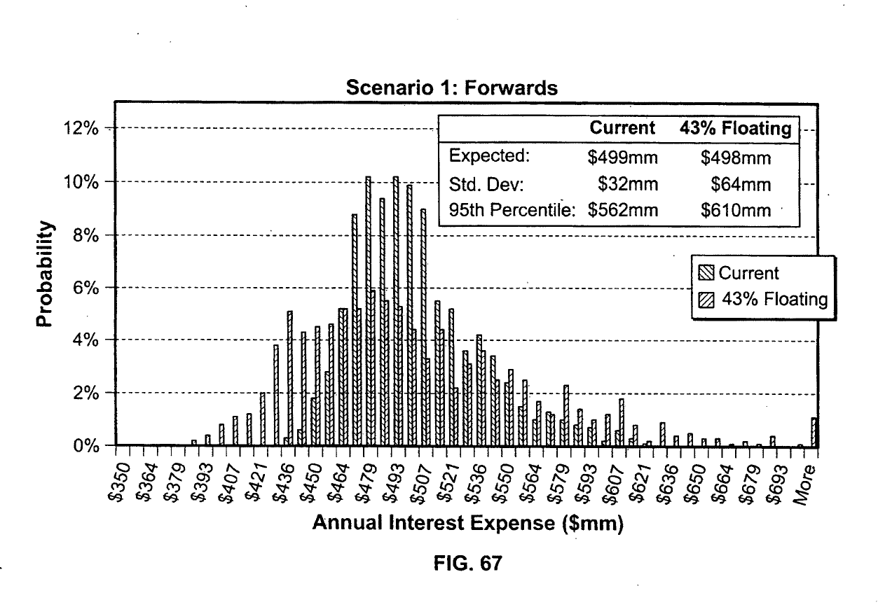

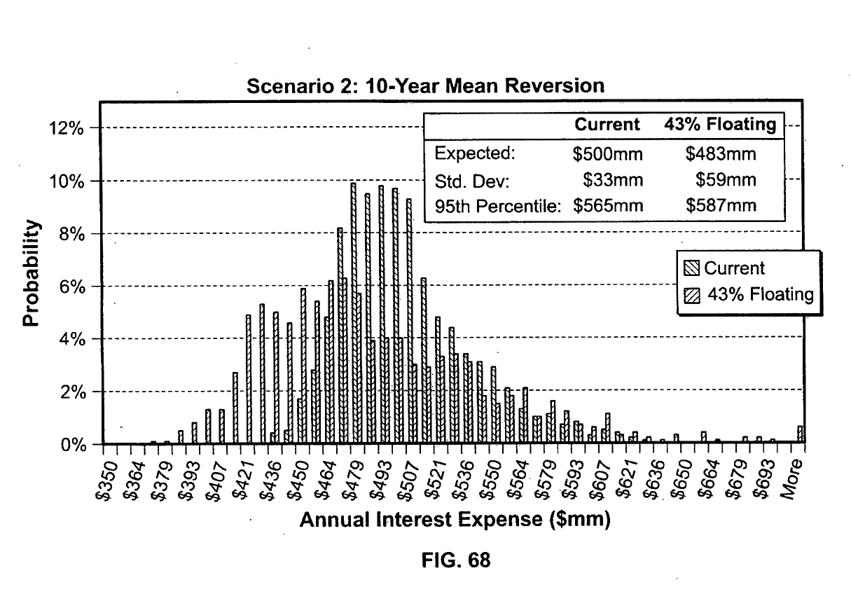

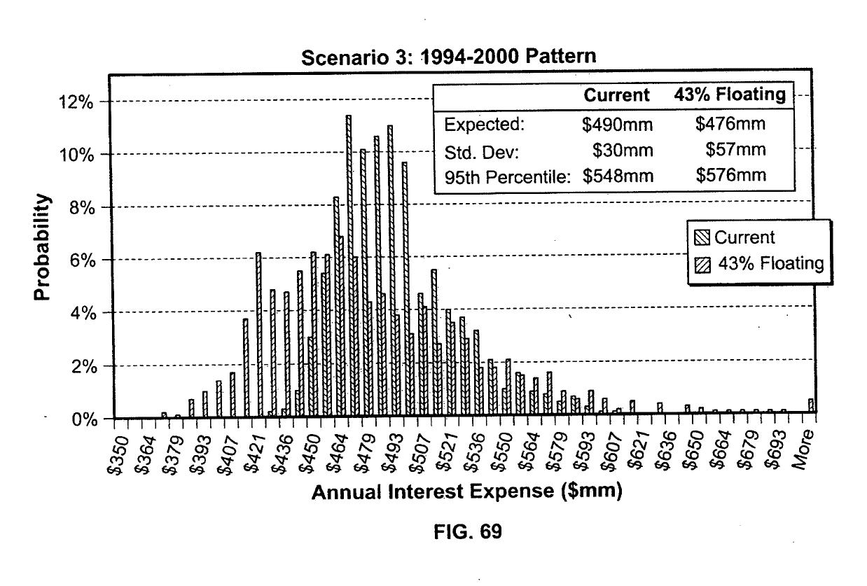

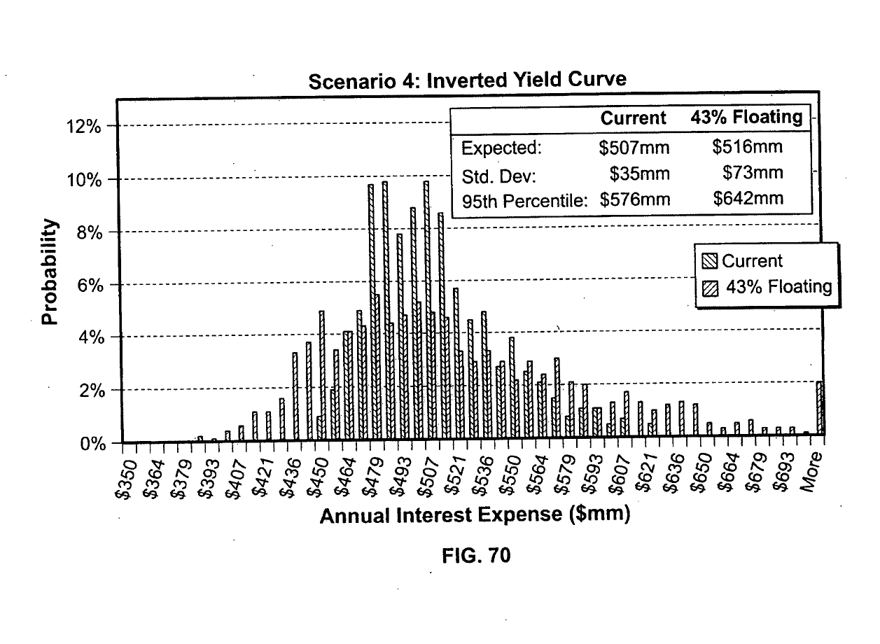

FIGS. 67-70 depict 43% relative to current. The increase in standard deviation of annual IE is $26-38 million—double the increase of the 27% scenario.

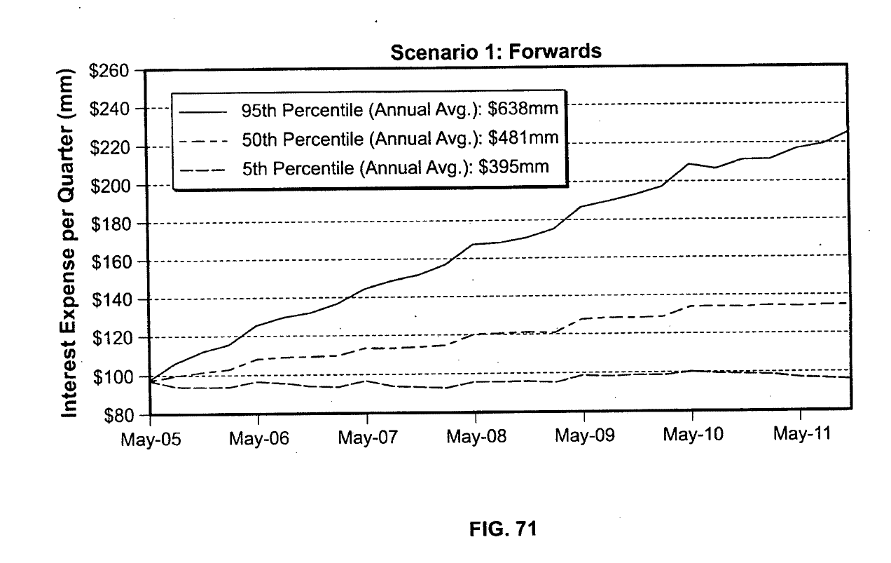

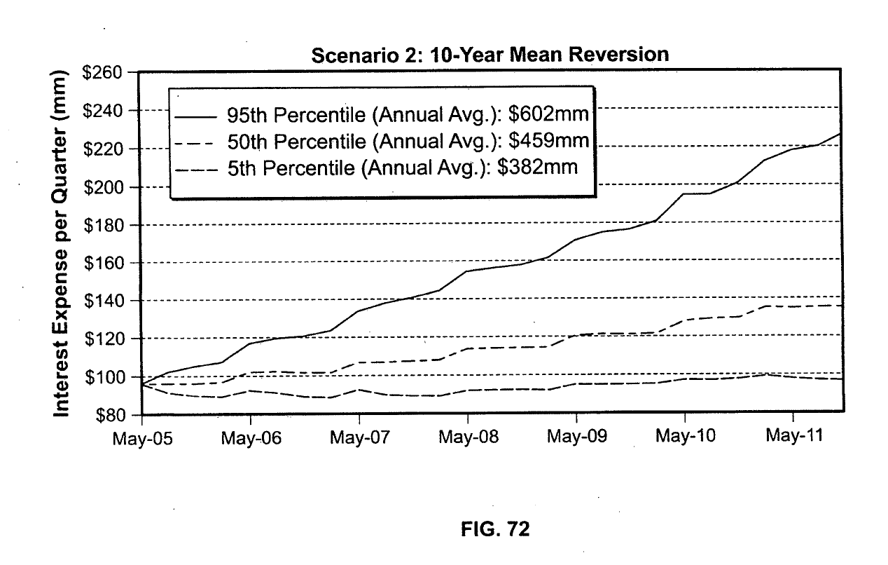

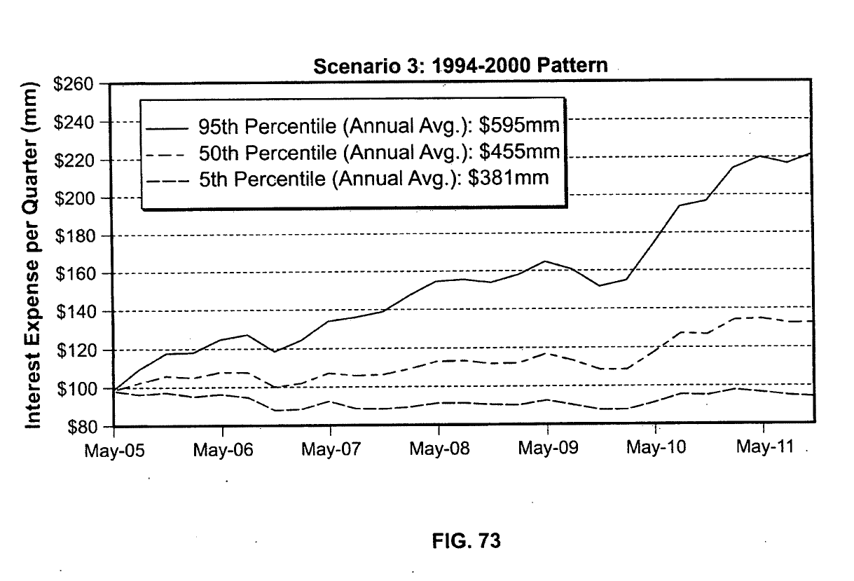

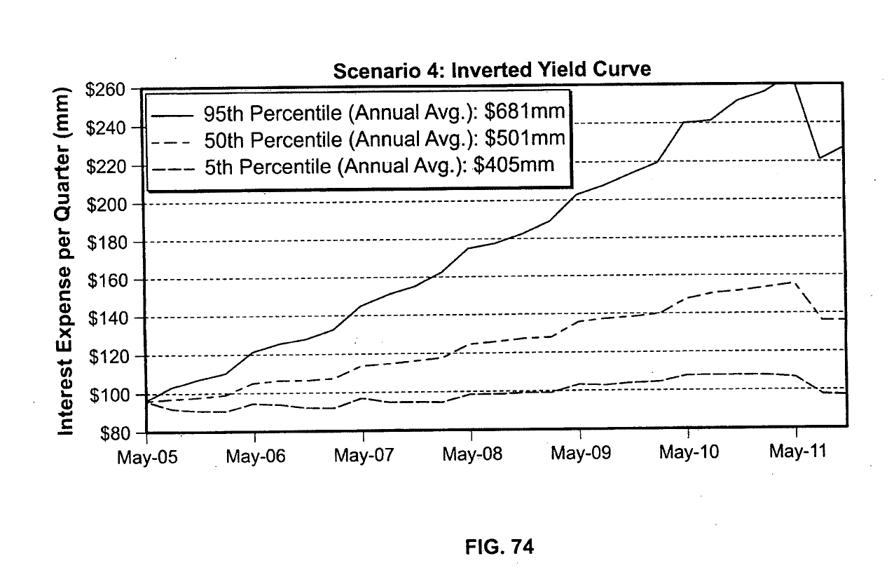

FIGS. 71-74 depict IE based on 60% floating interest projections. Compared to the 43% case, the range in median IE is relatively unchanged at $455-501 million.

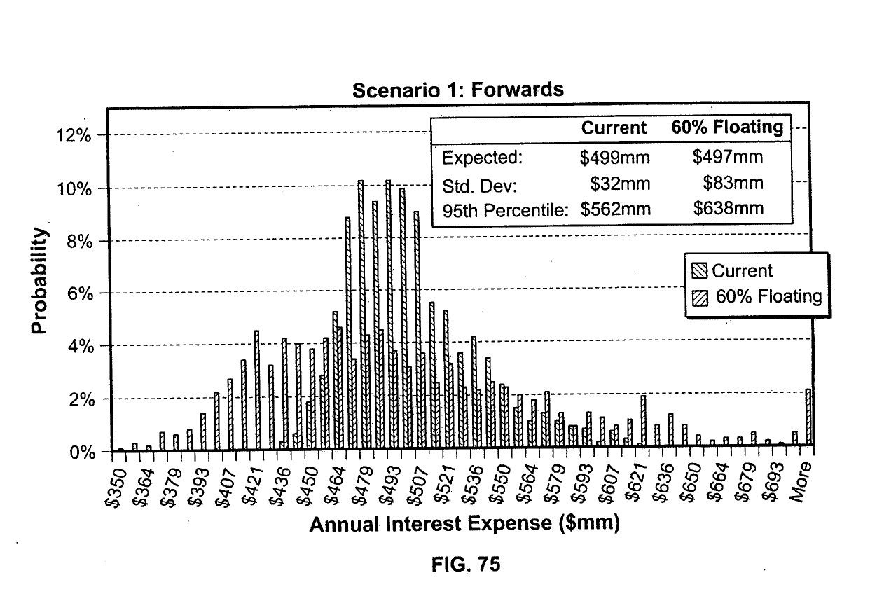

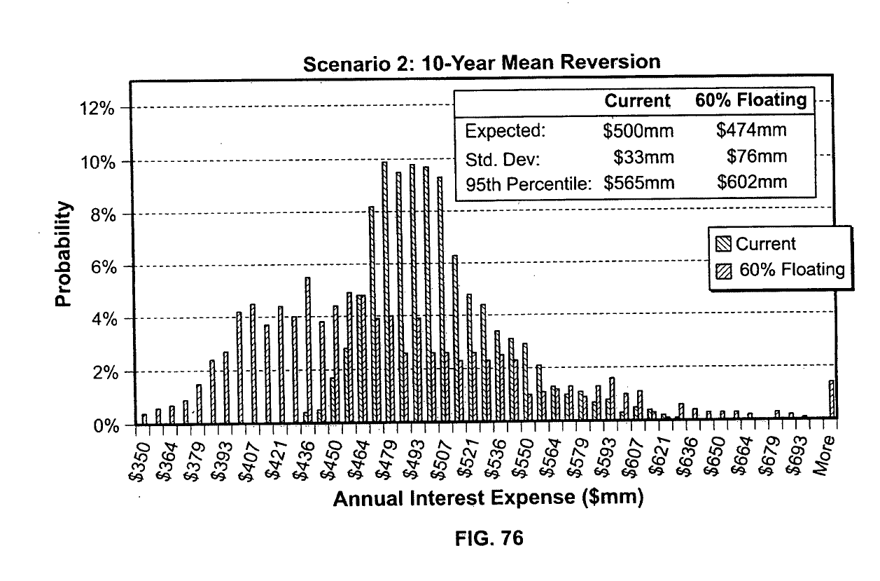

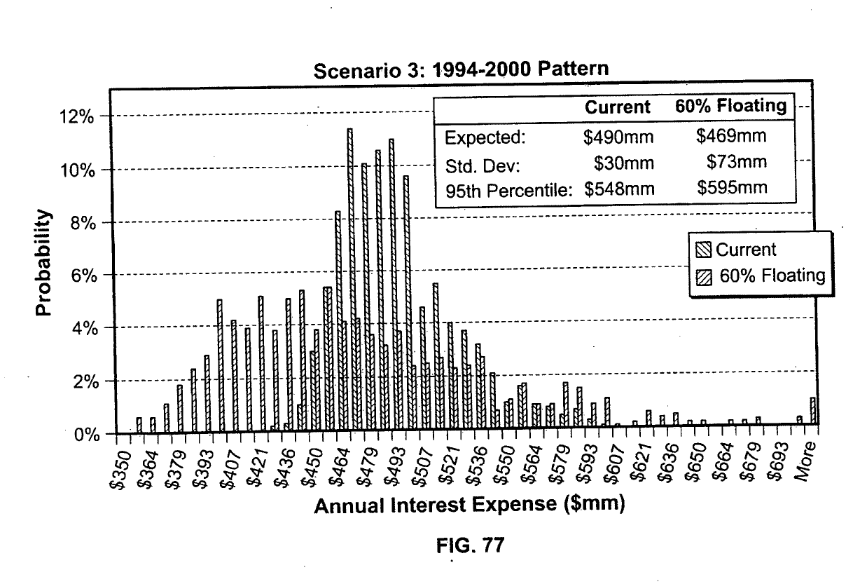

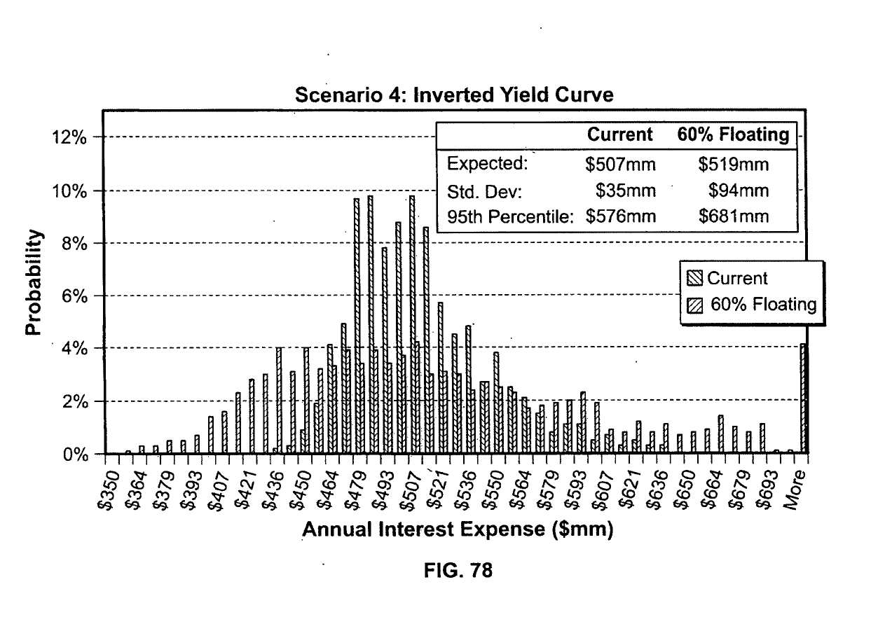

FIGS. 75-78 depict 60% relative to current. Although the range of median IE is relatively unchanged from the 43% case, the standard deviation increases about 30% across scenarios.

Forward Curves

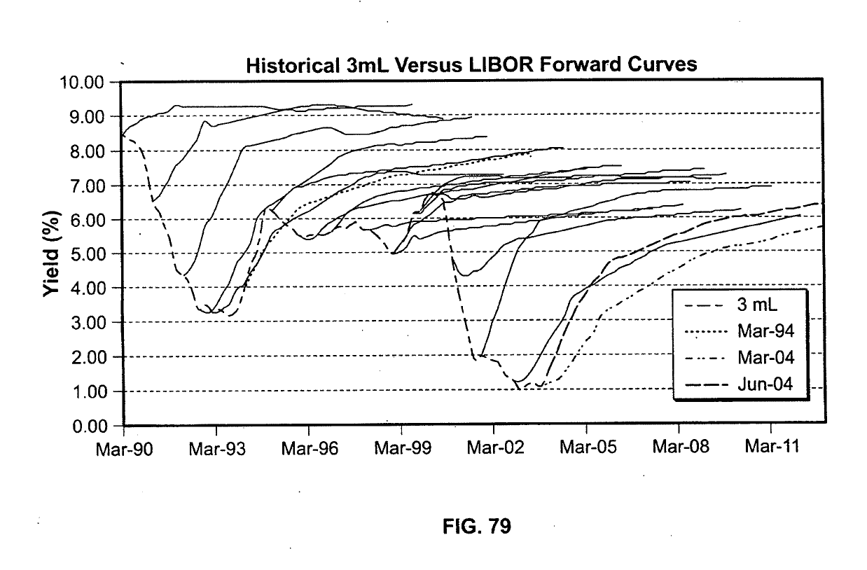

Implied LIBOR Forward rates are not accurate predictors of actual future LIBOR settings. FIG. 79 depicts historical implied LIBOR Forward Curves at various points dating back to 1990. Historically, forwards tend to over-predict where rates actually go. Forward curves historically tend to be flat to upward sloping regardless of the prevailing Fed bias to raise or lower interest rates. But the forward curve has over-predicted where 3 mL (3-month LIBOR) would be in 3 years by over 250 basis points on average (see TABLE 11).

TABLE 11
LIBOR Forward Curves vs. Actual 3 mL

| Statistics in bps | | | | |
|---|---|---|---|---|
| Overprediction | Average | Median | Max | Min |
| 3 m | 21 | 14 | 144 | −41 |
| 6 m | 50 | 32 | 265 | −84 |
| 9 m | 84 | 57 | 309 | −116 |
| 1.0 y | 120 | 89 | 381 | −178 |
| 1.5 y | 182 | 138 | 534 | −179 |
| 2.0 y | 233 | 188 | 546 | −163 |
| 2.5 y | 248 | 182 | 589 | −72 |
| 3.0 y | 259 | 199 | 616 | −44 |
| 3.5 y | 268 | 220 | 608 | −46 |
| 4.0 y | 275 | 264 | 611 | −15 |
| 4.5 y | 284 | 305 | 574 | −63 |
| 5.0 y | 301 | 314 | 535 | −31 |

Swap to Floating Analysis

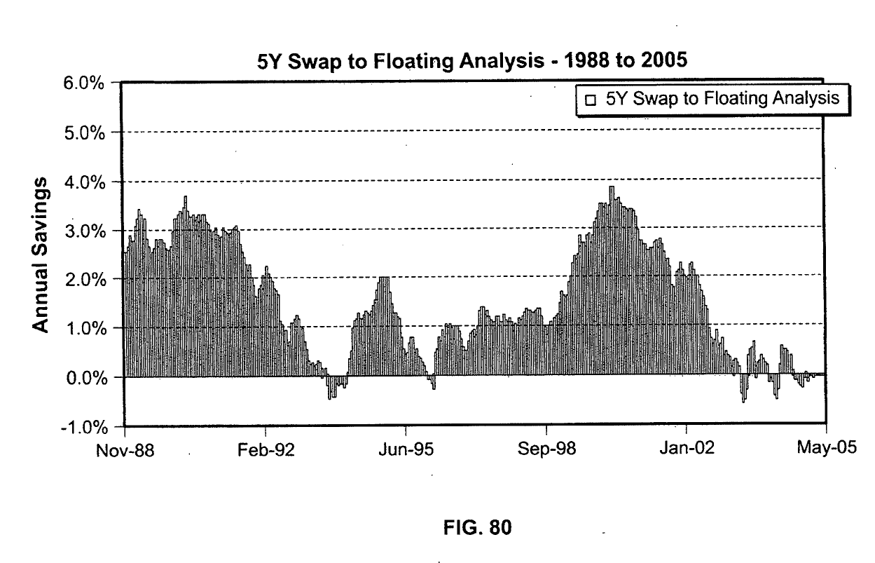

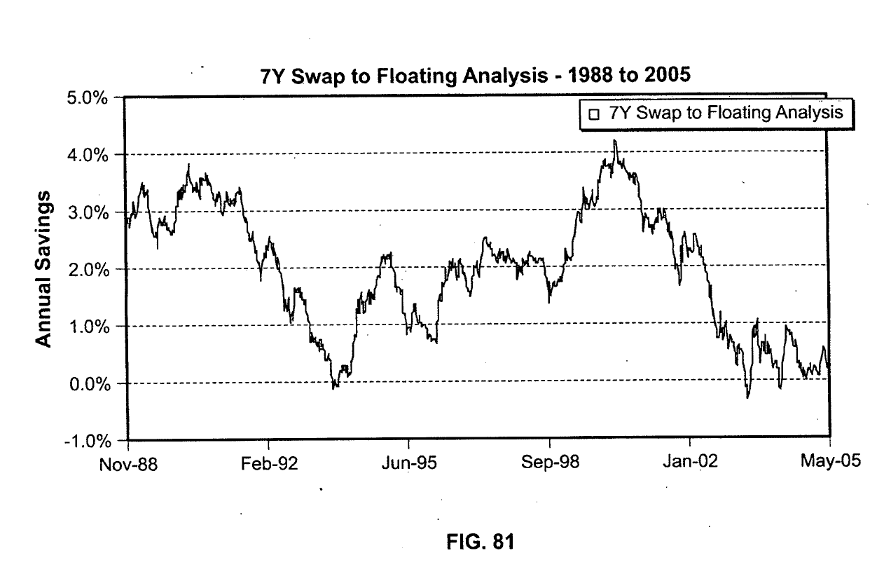

FIGS. 80-81 depict annual NPV savings from a 5- and 7-year swap to floating.

Observations: (1) Since 1988, an issuer would have averaged 1.69% NPV annual savings by swapping to floating for 5-years; a 5-year swap to floating would have lowered interest expense 92% of the time on an NPV basis since 1988. And (2) Since 1988, an issuer would have averaged 1.85% NPV annual savings by swapping to floating for 7-years; a 7-year swap to floating would have lowered interest expense 97% of the time on an NPV basis since 1988.

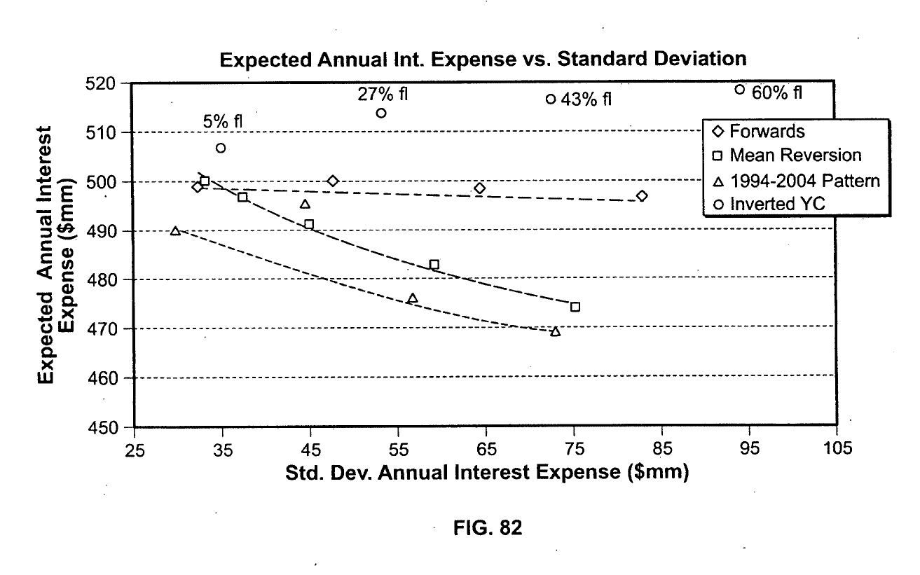

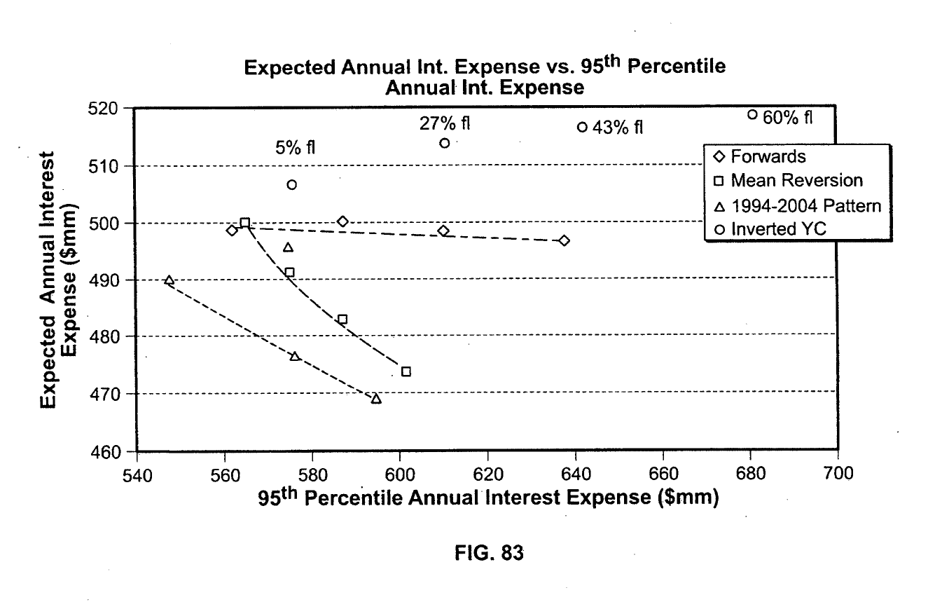

FIGS. 82-83 depict ABC's “efficient frontier.” Dotted lines show efficient frontiers with increasing floating rate percentage.

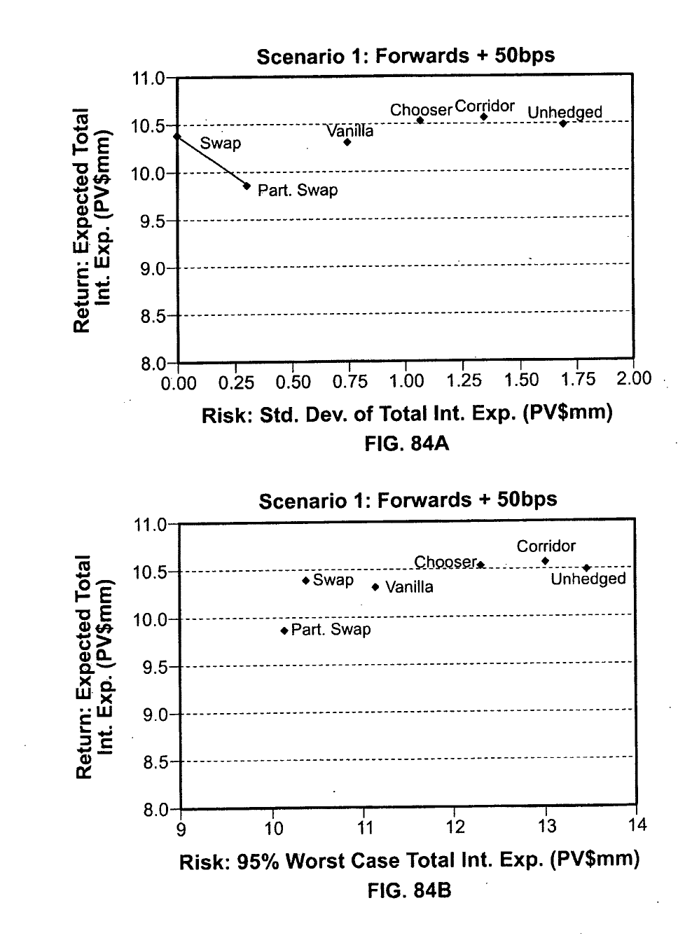

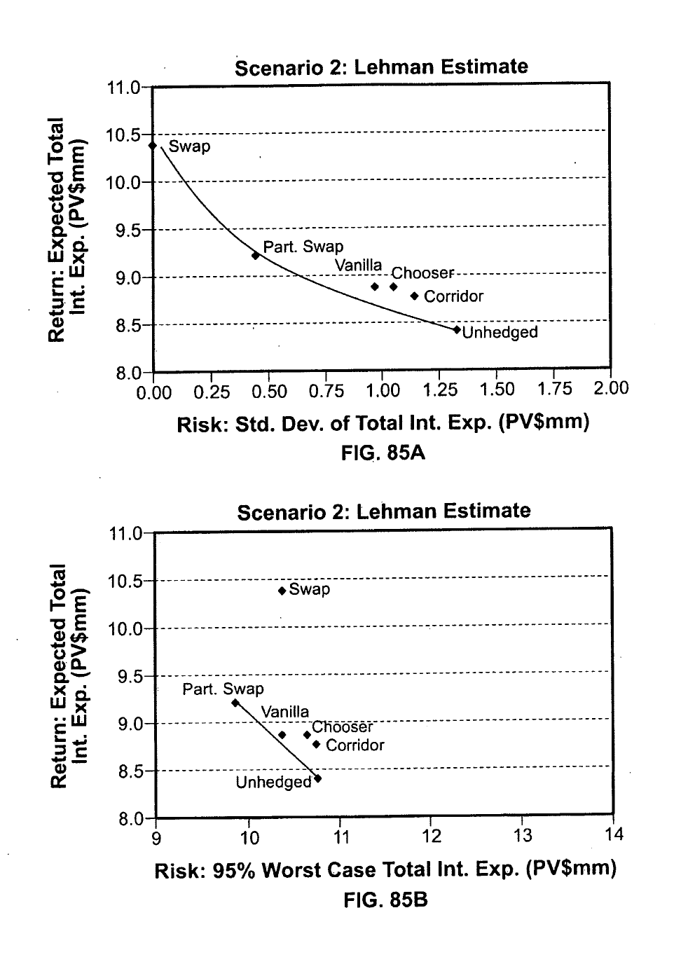

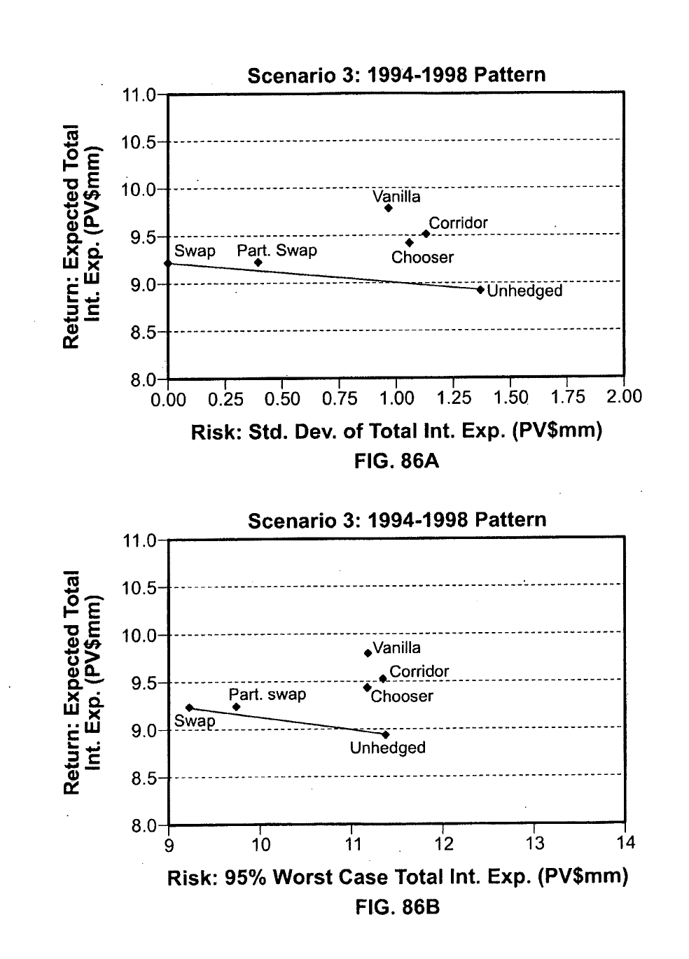

Examples of risk management strategies are depicted in FIGS. 84A-84B, 85A-85B and 86A-86B. For FIGS. 84A-84B, the efficient cap strategy is a participating swap. For FIGS. 85A-85B, the efficient cap strategy is a combination of participating swap and unhedged, depending on risk/return preference. For FIGS. 86A-86B, the efficient cap strategy is a combination of vanilla swap and unhedged, depending on risk/return preference.

This description generally refers to risk distribution and either interest expense or net interest margin. But as explained above, the invention also encompasses charts, displays, and methods that characterize risk in present value (“PV”) terms. Analogous displays are used, but the variable is PV instead of interest expense. Those skilled in the art will recognize that the invention may also be applied to displays of other variables, as appropriate.

Also, although the term “accounting performance” is used herein, those skilled in the art will recognize that economic performance data could be substituted without departing from the spirit and scope of the invention.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

1-42. (canceled)

43. A computer system comprising:
a computer readable medium storing data regarding at least one interest rate sensitive asset and at least one interest rate sensitive liability;
a processor that is programmed to perform an interest rate simulation comprising applying a plurality of interest rate scenarios to said at least one interest rate sensitive asset and said at least one interest rate sensitive liability;
a processor that is programmed to calculate potential interest income and potential interest expense based on said interest rate simulation;
a processor that is programmed to determine at least one probability distribution of potential net interest margin based on said potential interest income and said potential interest expense; and
a processor that is programmed to configure said at least one probability distributions for display.

44. A computer system as in claim 43, wherein said processor that is programmed to determine at least one probability distribution is programmed to determine a plurality of potential net interest margin percentiles over time, and wherein said processor that is programmed to configure said at least one probability distribution for display is programmed to configure a chart comprising 50th percentile net interest margin over time, 95th percentile net interest margin over time, and 5th percentile net interest margin over time.

45. A computer system as in claim 43, wherein said processor that is programmed to determine at least one probability distribution is programmed to determine a corresponding net interest margin probability distribution for each of at least two interest rate scenarios, and wherein said processor that is programmed to configure said at least one probability distribution for display is programmed to configure a chart comprising each of said corresponding net interest margin probability distributions.

46. A computer system as in claim 45, wherein said at least two interest rate scenarios comprise two or more of:
a forwards scenario;
an X/Y mean reversion scenario;
a Z year pattern assumption scenario; and
an inverted yield curve scenario.

47. A computer system as in claim 46, wherein said processor that is programmed to configure said at least one probability distribution for display is programmed to configure a chart comprising at least one net interest margin probability distribution without said risk management product and at least one net interest margin probability distribution with said risk management product.

48. A computer system as in claim 43, wherein said processor that is programmed to perform said interest rate simulation is programmed to apply at least one risk management product distinct from said at least one interest rate sensitive asset and said at least one interest rate sensitive liability.

49. A computer system as in claim 43, wherein said processor that is programmed to perform an interest rate simulation is programmed to apply a blended scenario comprising a combination of at least two interest rate scenarios.

50. A computer system as in claim 43, wherein said processor that is programmed to configure said at least one probability distribution for display is programmed to configure a median high-low chart comprising one or more vertical bars, wherein each of said one or more vertical bars represents one of said at least one probability distribution.

51. A computer system as in claim 50, wherein each of said one or more vertical bars comprises an uppermost dot that represents a 95% best case for potential net interest margin, a lowermost dot that represents a 95% worst case potential net interest margin, and a center dot that represents an expected level of potential net interest margin.

52. A computer system as in claim 50, wherein said processor that is programmed to determine at least one probability distribution is programmed to determine a corresponding net interest margin probability distribution for each of at least two interest rate scenarios, and wherein said processor that is programmed to configure said median high-low chart is programmed to configure a vertical bar in said chart for each of said corresponding net interest margin probability distributions.

53. A computer system as in claim 52, wherein said at least two interest rate scenarios comprise two or more of:
a forwards scenario;
an X/Y mean reversion scenario;
a Z year pattern assumption scenario; and
an inverted yield curve scenario.

54. A computer system as in claim 50, wherein said processor that is programmed to perform said interest rate simulation is programmed to apply at least one risk management product distinct from said at least one interest rate sensitive asset and said at least one interest rate sensitive liability.

55. A computer system as in claim 54, wherein said potential interest income and said potential interest expense are further based on said at least one risk management product, and wherein said at least one distribution of potential net interest margin is further based on said at least one risk management product.

56. A computer system as in claim 55, wherein said at least one risk management product comprises one or more of: swaps, collars, caps, floors, swaptions, and forward starting swaps.

57. A computer implemented method comprising:
performing an interest rate simulation, using a processor, comprising applying a plurality of interest rate scenarios to data regarding at least one interest rate sensitive asset and data regarding at least one interest rate sensitive liability stored on a computer readable medium;
calculating, using a processor, output of said interest rate simulation; and
based on said output, generating, using a processor, and displaying on a computer screen a median high-low chart comprising one or more vertical bars,
wherein each of said one or more vertical bars represents a probability distribution,
wherein each of said one or more vertical bars comprises a center dot, an uppermost dot, and a lowermost dot, and wherein said center dot represents an expected level of interest cost.

58. A computer implemented method as in claim 57, wherein for each of said one or more vertical bars, said uppermost dot represents a 95% best case for projected accounting performance and said lowermost dot represents a 95% worst case for projected accounting performance.

59. A computer implemented method as in claim 58, wherein said projected accounting performance comprises one or more of: net interest margin, interest expense, interest income, and present value.

60. A computer implemented method as in claim 58, wherein said projected accounting performance comprises net interest margin.

61. A computer implemented method as in claim 57, wherein at least one of said one or more vertical bars corresponds to an interest rate scenario.

62. A computer implemented method as in claim 61, wherein said interest rate scenario comprises at least one of:
a forwards scenario;
an X/Y mean reversion scenario;
a Z year pattern assumption scenario; and
an inverted yield curve scenario.

63. A computer implemented method as in claim 62, wherein said chart comprises, for at least one of said one or more vertical bars that corresponds to an interest rate scenario, one or more vertical bars corresponding to a risk management product scenario.

64. A computer implemented method as in claim 63, wherein said risk management product scenario comprises a scenario for one or more of: swaps, collars, caps, floors, swaptions, and forward starting swaps.

65. A computer system comprising:
a processor that is programmed to perform an interest rate simulation comprising applying a plurality of interest rate scenarios to data regarding at least one interest rate sensitive asset and data regarding at least one interest rate sensitive liability stored on a computer readable medium; and
a processor that is programmed to generate and a computer operable to display on a computer screen a chart illustrating level and volatility of a projected accounting performance based on said interest rate simulation,
wherein said chart comprises a 50th percentile line, a 95th percentile line, and a 5th percentile line, and
wherein said 50th percentile line, 95th percentile line, and 5th percentile line represent probability distribution over time of said projected accounting performance.

66. A computer system as in claim 65, wherein said 95th percentile line and said 5th percentile line form a cone that models potential volatility of said projected accounting performance.

67. A computer system as in claim 65, wherein said projected accounting performance is projected accounting performance per quarter.

68. A computer system as in claim 65, wherein said projected accounting performance is based on at least one interest rate scenario.

69. A computer system as in claim 68, wherein said at least one interest rate scenario comprises one or more of:
a forwards scenario;
an X/Y mean reversion scenario;
a Z year pattern assumption scenario; and
an inverted yield curve scenario.

70. A computer system as in claim 65, wherein said accounting performance comprises at least one of: net interest margin, interest expense, interest income, and present value.

71. A computer system as in claim 65, wherein said accounting performance comprises net interest margin.

72. A computer system as in claim 65, wherein said accounting performance comprises a combination of two or more of: net interest margin, interest expense, interest income, and present value.

73. A computer system comprising:
a processor that is programmed to perform an interest rate simulation comprising applying a plurality of interest rate scenarios to data regarding at least one interest rate sensitive asset and data regarding at least one interest rate sensitive liability stored on a computer readable medium;
a processor that is programmed to calculate output of said interest rate simulation; and
a processor that is programmed to generate, based on said output, and a computer operable to display on a computer screen a median high-low chart comprising one or more vertical bars,
wherein each of said one or more vertical bars represents a probability distribution,
wherein each of said one or more vertical bars comprises a center dot, an uppermost dot, and a lowermost dot, and wherein said center dot represents an expected level of interest cost.

74. A computer system as in claim 73, wherein for each of said one or more vertical bars, said uppermost dot represents a 95% best case for projected accounting performance and said lowermost dot represents a 95% worst case for projected accounting performance.

75. A computer system as in claim 74, wherein said projected accounting performance comprises one or more of: net interest margin, interest expense, interest income, and present value.

76. A computer system as in claim 73, wherein at least one of said one or more vertical bars corresponds to an interest rate scenario.

77. A computer system as in claim 76, wherein said interest rate scenario comprises at least one of:
a forwards scenario;
an X/Y mean reversion scenario;
a Z year pattern assumption scenario; and
an inverted yield curve scenario.

78. A computer system as in claim 76, wherein said chart comprises, for at least one of said one or more vertical bars that corresponds to an interest rate scenario, one or more vertical bars corresponding to a risk management product scenario.

79. A computer system as in claim 78, wherein said risk management product scenario comprises a scenario for one or more of: swaps, collars, caps, floors, swaptions, and forward starting swaps.

80. A computer system as in claim 74, wherein said projected accounting performance comprises net interest margin.
